(19) United States
(12) Patent Application Publication
(10) Pub. No.: US 2015/0248645 A1
(43) Pub. Date: Sep. 3, 2015

(54) SCORING MODEL METHODS AND APPARATUS

(71) Applicant: Zlemma, Inc., Fremont, CA (US)

(72) Inventors: Ashwin Rao, Palo Alto, CA (US); Gaurav Bubna, Kolkata (IN)

(73) Assignee: Zlemma, Inc., Fremont, CA (US)

(21) Appl. No.: 14/195,169

(22) Filed: Mar. 3, 2014

(51) Int. Cl. G06Q 10/10; G06Q 10/06

(52) U.S. Cl. CPC G06Q 10/105; G06Q 10/0631

(57) ABSTRACT

Techniques for calculating a talent score for a candidate for a job, the talent score being indicative of the candidate's suitability for the job. The techniques include calculating a first value for a first credential of a candidate for a job and a measure of uncertainty for the first value, the first credential indicative of the candidate's knowledge and/or skill in a first area, the first value indicative of an amount of knowledge and/or skill the candidate has in the first area; obtaining an employer's credential value preferences for the job; and calculating a talent score for the candidate and a corresponding measure of uncertainty based, at least in part, on the first value, the credential value preferences, and the measure of uncertainty for the first value.

### BACKGROUND

In recruiting a person for a job, an employer may identify candidates for the job, evaluate the suitability of each identified candidate for the job, and select one of the candidates for hiring or further consideration based on results of the evaluations. The employer may identify candidates for the job by advertising the job and reviewing job inquiries or applications received in response to the advertising. The employer may advertise the job via various media outlets such as local newspapers, national newspapers, professional publications, job centers, the Internet, etc. The employer may also use recruitment consultants, networking events, and/or other recruiting techniques to identify candidates for the job.

After candidates for the job are identified, the employer may evaluate the suitability of each identified candidate for the job by reviewing the candidate's credentials and/or interviewing the candidate. A candidate's credentials may be provided by the candidate (e.g., resume, cover letter, transcripts, etc.) and/or may be otherwise obtained by the employer (e.g., a recommendation of the candidate provided by a third party). Based on such an evaluation, the employer may decide that the candidate is not suitable for the job, decide to further evaluate the candidate's suitability for the job, or offer the job to the candidate.

### SUMMARY

Some embodiments are directed to a method comprising using at least one hardware computer processor to perform obtaining information associated with a job; obtaining, via an online service having an associated plurality of users, credential information for each of a plurality of candidates associated with the online service, the plurality of candidates identified from among the plurality of users associated with the online service; calculating a talent score for each one of the plurality of candidates based at least in part on a credential value for a credential specified in the credential information of the each one candidate and the information associated with the job; and ranking the plurality of candidates based on the calculated talent scores.

Some embodiments are directed to at least one non-transitory computer-readable storage medium encoded with processor-executable instructions that, when executed by at least one hardware computer processor, cause the at least one hardware computer processor to perform: obtaining information associated with a job; obtaining, via an online service having an associated plurality of users, credential information for each of a plurality of candidates in the online service, the plurality of candidates identified from among the plurality of users associated with the online service; calculating a talent score for each one of the plurality of candidates based at least in part on a credential value for a credential specified in the credential information of the each one candidate and the information associated with the job; and ranking the plurality of candidates based on the calculated talent scores.

Some embodiments are directed to a system comprising at least one hardware computer processor configured to perform: obtaining information associated with a job obtaining, via an online service having an associated plurality of users, credential information for each of a plurality of candidates in the online service, the plurality of candidates identified from among the plurality of users associated with the online service; calculating a talent score for each one of the plurality of candidates based at least in part on a credential value for a credential specified in the credential information of the each one candidate and the information associated with the job; and ranking the plurality of candidates based on the calculated talent scores.

Some embodiments are directed to a method comprising using at least one hardware computer processor to perform: calculating a first value for a first credential of a candidate for a job and a measure of uncertainty for the first value, the first credential indicative of the candidate's knowledge and/or skill in a first area, the first value indicative of an amount of knowledge and/or skill the candidate has in the first area; obtaining an employer's credential value preferences for the job; and calculating a talent score for the candidate and a corresponding measure of uncertainty based, at least in part, on the first value, the credential value preferences, and the measure of uncertainty for the first value.

Some embodiments are directed to at least one non-transitory computer-readable storage medium storing processor-executable instructions that, when executed by at least one hardware computer processor, cause the at least one hardware computer processor to perform a method. The method comprises: calculating a first value for a first credential of a candidate for a job and a measure of uncertainty for the first value, the first credential indicative of the candidate's knowledge and/or skill in a first area, the first value indicative of an amount of knowledge and/or skill the candidate has in the first area; obtaining an employer's credential value preferences for the job; and calculating a talent score for the candidate and a corresponding measure of uncertainty based, at least in part, on the first value, the credential value preferences, and the measure of uncertainty for the first value.

Some embodiments are directed to a system comprising at least one hardware computer processor configured to perform: calculating a first value for a first credential of a candidate for a job and a measure of uncertainty for the first value, the first credential indicative of the candidate's knowledge and/or skill in a first area, the first value indicative of an amount of knowledge and/or skill the candidate has in the first area; obtaining an employer's credential value preferences for the job; and calculating a talent score for the candidate and a corresponding measure of uncertainty based, at least in part, on the first value, the credential value preferences, and the measure of uncertainty for the first value.

### BRIEF DESCRIPTION OF DRAWINGS

Various aspects and embodiments of the application will be described with reference to the following figures. It should be appreciated that the figures are not necessarily drawn to scale.

FIG. 1 shows an illustrative environment in which some embodiments may operate;

FIG. 2 is a flow chart of an illustrative process performed by a talent scoring system for calculating a talent score indicative of a candidate's suitability for a job based on credential value preferences specified by an employer for the job, in accordance with some embodiments;

FIG. 3 is a flow chart of an illustrative process performed by a talent scoring system for calculating a respective talent score indicative of a candidate's suitability for each of multiple jobs based on credential value preferences associated with each of the multiple jobs, in accordance with some embodiments;

FIG. 4 is a flow chart of an illustrative process performed by a talent scoring system for calculating a talent score indicative of a candidate's suitability for a job based on credential value preferences specified by the candidate for the job, in accordance with some embodiments;

FIG. 5A is a flow chart of an illustrative process performed by a talent scoring system for calculating a talent score indicative of a candidate's suitability for a job at least in part by calculating a first score for at least one of the candidate's primary credentials and a second score for at least one of the candidate's secondary credentials, in accordance with some embodiments;

FIG. 5B is a flow chart of an illustrative process performed by a talent scoring system for calculating a talent score indicative of a candidate's suitability for a job and an associated measure of uncertainty, in accordance with some embodiments;

FIG. 6 is a flow chart of an illustrative process performed by a talent scoring system for calculating score of a candidate's credential based on value preferences specified for the credential or a related credential area, in accordance with some embodiments;

FIG. 7 shows an illustrative example of a user interface that may be provided to a candidate by a talent scoring system, in accordance with some embodiments;

FIGS. 8A and 8B illustrate a mapping from a credential value to a score, in accordance with some embodiments;

FIG. 9 illustrates a credentials graph, in accordance with some embodiments;

FIG. 10 is a flow chart of an illustrative process performed by a talent scoring system for recommending one or more credentials for a candidate to obtain, in accordance with some embodiments;

FIG. 11 shows another illustrative environment in which some embodiments may operate;

FIG. 12 is a flow chart of an illustrative process performed by a talent scoring system of calculating talent scores for candidates identified from among users associated with an online service, in accordance with some embodiments; and

FIG. 13 shows an illustrative example of a user interface that may be used by an employer to interact with a talent scoring system in order to identify suitable job candidates among users of an online service, in accordance with some embodiments;

FIG. 14 is a block diagram of an illustrative computer system that may be used in implementing some embodiments.

### DETAILED DESCRIPTION

The inventor has appreciated that conventional approaches to recruiting candidates for jobs require significant manual effort to be expended, which is not only costly from a time and money perspective, but manually driven approaches to evaluating candidates often injects unwanted subjectivity into the process. As discussed above, manual effort is needed to identify candidates for the job as well as to evaluate the suitability of each identified candidate for the job. Often multiple people are involved in each of these tasks such as, for example, one or more human resources personnel of an employer, third-party human resources personnel (e.g., recruiting consultants), one or one or more employees (e.g., employees whose jobs relate to the job for which candidates are sought), and/or other personnel.

Such personnel may expend significant amounts of time preparing and placing job advertisements, providing information about the job to candidates requesting further information about the job, gathering and evaluating credentials for each candidate that shows interest and/or applies for the job, interviewing candidates, comparing evaluations of candidates performed by different people, etc. As a result, the overall hiring effort is slow, results in hiring delays and may involve significant costs, due at least in part to processing candidates that may be unsuitable and/or are unlikely to be the best fit for the job.

The inventor has appreciated that an improved approach to recruiting could be provided if the task of evaluating the suitability of a candidate for a job could be at least partially automated. Thus, some embodiments described herein relate to automating one or more aspects of evaluating the suitability of a candidate for a job based on the candidate's credentials. The inventor has also appreciated that, when seeking candidates for a job, employers find it difficult to articulate precisely the profile of candidates they are seeking. For example, an employer may specify that, for a particular job, the employer prefers a candidate that has an undergraduate degree in economics, has programming experience, and speaks Japanese.

In the example above, it is not clear from these preferences alone, however, whether the employer seeks candidates with an undergraduate degree in economics from any university or specific universities (e.g., universities having an economics department ranked among the top-ten). It is also unclear how much programming expertise the employer desires candidates for the job to have (e.g., basic familiarity, some experience, or extensive experience with programming). It is also unclear how much facility with Japanese (e.g., familiarity, proficiency, or fluency) is desired.

Imprecisely specified preferences may lead to employers receiving inquiries and applications from candidates that loosely meet the credentials the employer is seeking, but who may not be the candidate the employer is specifically targeting. Thus, without better means for specifying preferences, the candidate pool on which an employer must perform further diligence may include numerous candidates that are not a suitable fit and/or the candidate pool may not include candidates representing the best fit for the job.

As an example of the above described issue, if an employer is seeking candidates with an undergraduate economics degree only from universities having one of the top-ten ranked economics departments, the employer may receive job inquires and/or applications from candidates having an economics degree from other universities that the employer is not inclined to consider. As another example, if the employer is seeking candidates having a basic familiarity with programming, the employer may receive job applications from candidates having extensive experience with programming that may for one reason or another be less suitable for the job than less experienced programmers. Not only do these less desirable candidates frequently undergo costly further processing, without more precise credential specifications, the more appropriate candidates may even be excluded from the candidate pool in mistaken preference for candidates that do not provide as suitable a fit.

It may often be the case that when an employer specifies multiple credentials for a candidate, the employer may not specify the extent to which these credentials matter when evaluating the candidate (e.g., the employer may not specify the significance each credential will play in evaluating the suitability of candidates). For instance, in the above-described example, it is unclear whether or not the employer prefers someone with extensive programming experience and proficiency in Japanese to someone who is fluent in Japanese, but only has basic familiarity with programming. That is, one or the other specified credential may be of secondary significance in connection with suitability for a given job. Such imprecision may lead to a mismatch between the types of candidates applying for a job and the types of candidates that the employer seeks.

The inventor has recognized that an improved approach to identifying and evaluating candidates for a job could be provided if employers were able to articulate more precisely the credentials they are seeking in candidates for a job. Thus, some embodiments described herein relate to providing tools for helping employers to specify their preferences for credentials as well to specify how much these credentials matter when evaluating candidates (e.g., by allowing employers to specify the significance of one or more specified credentials). In addition, the inventor has appreciated that identifying suitable candidates may be facilitated by automating the process of applying specified preferences to candidates to evaluate their suitability for a job.

Accordingly, some embodiments are directed to a talent scoring system and method configured to calculate a talent score of a candidate that is indicative of the candidate's suitability for a job. The talent scoring system/method may be configured to calculate the candidate's talent score based at least in part on one or more of the candidate's credentials. Additionally, the talent scoring system may be configured to calculate the candidate's talent score based at least in part on one or more credential value preferences specified for the job by an employer, a candidate seeking to understand his or her suitability for the job, or otherwise specified.

The inventors have appreciated that a talent score calculated based on the candidate's credentials and an employer's credential value preferences may have some degree of uncertainty resulting, at least in part, from the fact that the credentials used to obtain the talent score are not perfectly quantifiable with absolute certainty. Accordingly, an employer may be interested in ascertaining the level of certainty associated with a given talent score for a candidate. The inventors have developed techniques for computing a confidence interval or range about a given talent score that provides a measure of uncertainty associated with a given talent score. For example, a computed talent score of 85 with a relatively high level of certainty may have associated with it a range from 83 to 87, while a computed talent score of 85 with a relatively low level of certainty may have associated with it a (wider) range from 78 to 92. While the example uncertainty intervals above are symmetric about the talent score, in other embodiments the range of uncertainty may be asymmetric about the talent score.

Accordingly, some embodiments provide for techniques for computing a range for a given computed talent score based, at least in part, on the type and/or value of the credentials used in computing the talent score. This range provides a measure of the certainty associated with a given talent score. As such, according to some embodiments, a talent score provided to an employer and/or candidate may be accompanied by a minimum value and a maximum value defining the above-described range that characterizes the certainty/uncertainty of the associated talent score.

The inventors have further appreciated that online services provided for multiple users (frequently large numbers of users) such as business and/or professional online service sites such as LinkedIn® or Monster® and/or social networking sites such as Facebook® provide search facilities that allow users to search for individuals that have a certain set of qualifications that the user may be interested in. For example, an employer may search the LinkedIn® database for potential candidates that appear suitable for a given job. However, such searches frequently match numerous individuals that may be displayed to the user over multiple pages. As a result, individuals that best match the job from a qualification perspective may be one or more pages down the list of results and the user may not take the time to even view best match individuals. Even when strong matches appear early on in the list of search results, it is difficult to ascertain quickly and easily whether a given candidate is a strong match for the job.

Accordingly, some embodiments provide for an application program that receives profile information of individuals identified via a user search on an online service and generates a talent score for these individuals, with or without an accompanying measure of uncertainty (e.g., a confidence interval). The individuals may then be presented to the user ranked according to their talent scores and/or corresponding measures of uncertainty. As a result, the most suitable individuals will be presented to the user for quick and efficient investigation, and the user has immediate feedback with respect to the suitability of individuals returned by the search that meet the provided search criteria.

A credential of a candidate may be indicative of the candidate's knowledge and/or skill in one or more areas including, but not limited to, physical sciences, life sciences, social and behavioral sciences, technology, engineering, mathematical sciences, formal sciences, and/or any other suitable subjects and/or fields. For example, a candidate's undergraduate major in a field (e.g., economics) is a credential that may be indicative of the candidate's knowledge in that field. As another example, a candidate's knowledge of a programming language (e.g., Java) is a credential that may be indicative of the candidate's knowledge in computer science and the candidate's programming skills. As yet another example, a candidate's participation in a mathematics competition (e.g., the Putnam competition) is a credential that may be indicative of the candidate's knowledge and/or skill in mathematics. The above-listed credentials are illustrative non-limiting examples of possible credentials that may be considered.

A candidate may have academic credentials, professional credentials, publication credentials, competition credentials, awards and honors credentials, computer literacy credentials, language credentials, leadership and management credentials, and/or any other suitable types of credentials indicative of the candidate's knowledge and/or skill in one or more areas. Examples of academic credentials include, but are not limited to, the candidate's undergraduate school(s), degree(s), major(s), minor(s), undergraduate grades, undergraduate grade point average (GPA), graduate school(s), graduate degree(s), graduate school(s), graduate grades, graduate GPA, performance on one or more standardized examinations (e.g., SAT) and academic honors (e.g., Dean's List).

Examples of professional credentials include, but are not limited to, the candidate's prior and/or current job(s), length of employment at the prior and/or current job(s), responsibilities at the prior and/or current job(s), project(s) at the current and/or prior job(s), leadership or management roles at the prior and/or current jobs(s), either for prior and/or current jobs that were paid or unpaid. Professional credentials may also include professional certifications, licenses or the like.

Examples of publication credentials include, but are not limited to, research publications (e.g., a conference paper, a journal article, newspaper article, a book, and/or any other suitable type of publication) at least partially authored by the candidate, where and/or whom published the publication (e.g., name of an academic journal, name of a professional conference, name of publisher, etc.), one or more patent applications or issued patents on which the candidate is a named inventor, or any other suitable publication credential.

Examples of competition credentials include the name(s) of one or more competitions (e.g., a local/state/national programming competition, a local/state/national mathematics competition, a local/state/national physics competition, a local/state/national debate competition, etc.) in which the candidate participated and/or the performance of the candidate in the competition (e.g., placement). Examples of awards and honors credentials include, but are not limited to, one or more academic awards (e.g., Dean's list, honors such as summa cum laude, magna cum laude or cum laude, high distinction, etc.), community service awards, undergraduate/graduate research awards, scholarships, grants, etc.

Examples of computer literacy credentials include, but are not limited to, ability to program in one or more computer programming languages, knowledge of one or more operating systems, and knowledge of one or more application programs (e.g., computer-aided design application programs, statistical analysis application programs, mathematical programming application programs, database application programs, spreadsheet application programs, word processing application programs, etc.), industry and/or standards certifications, etc.

Examples of language credentials include an ability to speak, read, and/or write in one or more foreign languages. Language credentials may also include the ability to translate from one language to another, either orally in writing or both.

The above-listed credentials are non-limiting illustrative examples of credentials that may be considered and evaluated, but any other suitable credential of any suitable type may also be considered, as techniques described herein are not limited for use with the above-listed illustrative credentials. In addition, any suitable number of credentials of any suitable type may be considered, as techniques described herein are not limited for use to any particular number or set of credentials.

In some embodiments, a credential of a candidate may be associated with a value, herein termed “a credential value” or “value of a credential,” that may be indicative of the amount of knowledge and/or skill that the candidate has in one or more areas associated with the credential. For example, a value associated with a candidate's credential of an undergraduate degree in economics from a school with the top-ranked economics department may be indicative of an amount of knowledge/skill that the candidate has in economics. As another example, a value associated with a candidate's credential of having an undergraduate GPA of 3.7 may be indicative of an amount of knowledge/skill the candidate has in the area he/she majored in. As yet another example, a value associated with the credential of participating and/or placing in a programming competition may be indicative of an amount of knowledge/skill the candidate has in the areas of programming and/or computer science.

As another example, the prestige of an award may provide a value indicative of an amount of knowledge/skill the candidate possesses in this respect. As yet another example, a value associated with the credential of speaking Japanese may be indicative of the amount of candidate's facility with the Japanese language. These examples of credential values are illustrative and non-limiting, as any credential may be assigned a credential value that indicates the amount or extent the candidate possesses knowledge/skill with respect to the credential.

To further illustrate the concept of a credential value, consider the above-described credential of having an undergraduate degree in economics from a school with the top-ranked economics department. This value may be different (e.g., higher) than the credential of having an undergraduate degree in economics from a school with the 50^{th}-ranked economics department. The values of these credentials may be different because having an economics degree from a top-ranked department may be indicative of a greater amount of knowledge and/or skill in economics than having an economics degree from the 50^{th}-ranked department.

As another example, a value associated with the above-described credential of GPA=3.7 in a school where 30% of the students have a GPA greater than 3.7 may be different from the value associated with a credential of GPA=3.7 in a school where only 5% of students have a GPA greater than 3.7. As yet another example, a value associated with placing first in a national programming competition may be different from the value associated with placing first in a local programming competition. As yet another example, a value associated with the credential of speaking Japanese may be different for a candidate who is fluent in Japanese than for a candidate who is only proficient in Japanese.

A credential value may be of any suitable type provided it adequately reflects the amount or extent of knowledge/skill or aptitude a candidate is deemed to have with respect to the credential. According to some embodiments, the credential value may be a numeric value. This numeric value may be indicative of the amount of knowledge and/or skill that the candidate has in one or more areas. The credential value may be a number in a specified range (e.g., a real number between 0 to 1 inclusive, an integer between 0 and 100, a real number between 0 and 100, etc.). In some embodiments, multiple credentials may have numeric values. The numeric values of the multiple credentials may lie in the same range. For example, multiple credentials being evaluated may take on values in the range of 0 to 1.

In some embodiments, larger credential values may indicate a greater amount/extent of knowledge and/or skill that the candidate is deemed to possess. Thus, for example, the value associated with the credential of GPA being 3.7 in a school where 30% of the students have a GPA greater than 3.7 may be 0.6, whereas the value associated with the credential of GPA being 3.7 in a school where 5% of the students have a GPA greater than 3.7 may be 0.85. As another example, the value associated with the credential of speaking Japanese fluently may be 0.9, whereas the value associated with the credential of speaking Japanese only proficiently may be 0.5. However, in other embodiments, smaller credential values may indicate a greater amount of knowledge and/or skill that the candidate may have, as techniques herein are not limited to the way in which credential values are indicated or quantified.

According to some embodiments, the credential value may be a categorical value. For example, the credential value may take on the value of “Small,” “Medium,” or “Large” indicating a small, medium, or large amount of knowledge and/or skill that the candidate has in one more areas. For example, the value associated with the credential of speaking Japanese fluently may be “Large,” whereas the value associated with the credential of speaking Japanese only proficiently may be “Medium.” The above examples of categorical values are illustrative and non-limiting, as credential values may be assigned or labeled with any other suitable categorical values (e.g., “Low,” “Medium,” “High”, or “Basic,” “Proficient,” “Fluent,” etc.).

In some embodiments, a talent scoring system is configured to assign a value to each of one or more of the candidate's credentials. The talent scoring system may be configured to assign a value to a candidate's credential in any suitable way and, for example, may be configured to assign a value to the credential based on any available information accessible by the talent scoring system that is indicative of an amount of knowledge/skill indicated or implied by the credential of the candidate in the area of the credential.

As previously described, in some embodiments, a talent score of a candidate indicative of the candidate's suitability for a job may be calculated based on one or more credential preferences specified by an employer for the job. The credential preferences may specify one or more credentials that the employer is seeking in candidates to consider them for employment. In some embodiments, the credential preferences may also comprise preferences for values of preferred credentials. In this way an employer may specify not only that the employer prefers candidates to have knowledge and/or skill in a particular area, but also may specify the amount of knowledge and/or skill that the employer prefers the candidate to have in that particular area. Credential preferences that comprise at least one preferred value for at least one preferred credential are herein termed “credential value preferences.”

In some embodiments, credential value preferences may specify at least one preferred value for a credential to indicate an amount of knowledge/skill the employer prefers candidates to have in the area of the credential. For example, credential value preferences may specify at least one preferred value associated with the credential of participating and/or placing in a programming competition, which may be indicative of an amount of knowledge/skill the employer the candidate has in the area of computer science. However, a candidate may have many different credentials indicative of his/her knowledge/skills in computer science (e.g., computer science courses, computer science degree(s), knowledge of multiple programming languages, experience with sub-areas of computer science such as compilers, algorithms, databases, machine learning, etc.) and, as such, credential value preferences may specify one or more preferred value(s) for the area of computer science generally rather than specifying preferred values for each credential in the area of computer science that candidates may potentially have.

In this way, credential value preferences may specify, compactly, one or more preferred values for any credentials in the area of computer science. In this general manner, credential value preferences may be used to specify one or more preferred values for any credential in any suitable area, some non-limiting examples of which are described herein. However, it should be appreciated that credential value preferences may be specified for particular expertise in a given area, as there are no limitations on the number, type or variety of credentials for which credential value preferences may be specified. For example, credential value preferences may comprise one or multiple preferred values for each of any suitable number of the preferred credentials and/or areas, as techniques described herein are not limited in this respect.

As a non-limiting illustrative example, credential value preferences specified by an employer for a job may specify that the employer prefers candidates to have the credential of speaking Japanese and may further specify a preferred value for the credential of speaking Japanese. For example, the preferred value may be 0.9 on a scale from 0 to 1, where 0 indicates the least amount of knowledge and/or skill a candidate may have in speaking Japanese (e.g., none or novice level), and 1 indicates the greatest amount of knowledge and/or skill a candidate may have (e.g., native or fluency). In this way, the employer not only specifies that the employer seeks candidate who speak Japanese, but also specifies the amount of skill in speaking Japanese that the employer prefers candidates to have. As another non-limiting illustrative example, credential value preferences specified by an employer for a job may specify that the employer prefers candidates to have the credential of an undergraduate degree in economics and may further specify a preferred value for this credential, such as an undergraduate degree from a top ten ranked university and/or economics department.

Accordingly, in some embodiments, a talent scoring system may be configured to calculate a talent score of a candidate for a job based at least in part on one or more values of one or more credentials of the candidate. The talent scoring system may be configured to assign a value to each of one or more credentials of the candidate. The talent scoring system may further calculate the talent score based at least in part on credential value preferences that are associated with the job and that indicate at least one preferred value for one or more credentials preferred by the employer.

In some embodiments, a candidate's talent score may reflect how close the value of a candidate's credential is to the employer's preferred value for that credential. As such, the candidate's talent score may reflect whether the amount of knowledge/skill possessed by the candidate in the area of the credential is close to the amount of knowledge/skill that the employer desires candidates to have in that area. For example, if an employer indicates that 0.85 is a preferred value for the credential of having a GPA equal to 3.7, then the talent score of a candidate whose credential of having an undergraduate GPA equal to 3.7 has a value of 0.6 (e.g., when 30% of students at the candidate's school have a GPA greater than 3.7) may be lower than the talent score of a candidate whose same credential has a value of 0.85 (e.g., when 5% of students at the candidate's school have a GPA greater than 3.7).

As another example, if an employer indicates that 0.6 is a preferred value for the credential of speaking Japanese, then the talent score of a candidate whose credential of speaking Japanese has a value of 0.7 (e.g., if the candidate is only proficient in Japanese) may be higher than the talent score of a candidate whose credential of speaking Japanese has a value of 0.9 (e.g., if the candidate is fluent in Japanese). As yet another example, if an employer indicates that 0.9 is a preferred value for the area of computer science, then the talent score of a candidate whose credential of having a course in computer science has a value of 0.6 may be lower than the talent score of a candidate whose credential of publishing in a computer science journal has a value of 0.9.

It should be appreciated from the foregoing that an employer may not be seeking candidates having the highest possible values (e.g., 1.0) for each credential because an employer may not be seeking candidates having the greatest amount of knowledge and/or skill in at least some of the areas of interest to the employer. For example, an employer may not be seeking the best programmer for a job that only requires basic computer literacy. As another example, an employer may not be seeking the best mathematician for a job, when the employer views mathematical skills as helpful but not required for the job, and views other credentials as being more essential.

As yet another example, the employer may not be looking for candidates with the highest GPAs at the best schools, but rather for candidates in a specific range of GPAs (e.g., 3.3-3.7) from schools ranked in a particular range (e.g., schools ranked 10-40) because the employer believes such candidates are better suited for the job for one reason or another. Accordingly, an employer may specify credential value preferences that indicate a preferred value for a preferred credential, but the preferred value may or may not be the largest possible value of the preferred credential depending on the circumstances and the preferences of the employer seeking a fit, or the preferences of a candidate evaluating his/her suitability for one or more jobs.

An employer may wish to evaluate multiple candidates for a job based on their respective credentials. Accordingly, in some embodiments, a talent score for each of multiple candidates for a job may be calculated. The talent score for a particular candidate may be calculated based at least in part on at least one value of one or more credentials of the candidate and credential value preferences specified by the employer for the job. The candidates may be ranked based on their respective talent scores. The employer may use the ranked talent scores to identify candidates to evaluate further (e.g., to interview), to identify candidates to hire, and/or for any other suitable purpose.

The inventor has also appreciated that results of evaluating the suitability of a candidate for a job comprise information of interest not only to employers, but also to candidates seeking jobs. The candidate may use this information to answer questions such as “How talented am I?”, “Who would want to interview me?” or “How suitable am I for a particular job?” Accordingly in some embodiments, a talent score of a candidate may be calculated for a given job or for each of multiple jobs that are of interest to the candidate. The talent score for a particular job may be calculated based at least in part on at least one value of one or more credentials of the candidate and credential value preferences specified by the employer for the job (or alternatively specified by the candidate, as discussed in further detail below). The calculated talent score(s) may then be presented to the candidate to provide him/her with a measure of his/her suitability for the job(s) for which the talent score(s) were calculated. When multiple jobs are considered, the jobs may be ranked based on the talent score computed for the respective job. The candidate may use the ranked talent scores to identify the jobs they are most suitable for so that they can request more information, apply, and/or better understand how the candidate fits into the employment market.

As previously described, an employer may specify credential value preferences for a job. However, aspects of the disclosure provided herein are not limited in this respect and, in some embodiments, a candidate may specify credential value preferences for a job. For example, the candidate may specify credential value preferences for a “mock” job (e.g., a candidate's dream job) in order to evaluate himself with respect to these credential value preferences. Accordingly, in some embodiments, a talent score for a candidate for a job may be calculated based at least in part on at least one value of one or more credentials of the candidate and credential value preferences specified by the candidate for the job.

In some embodiments, a candidate may change credential value preferences, which the candidate previously specified, to determine the effect of these changes on the candidate's talent score. For example, a candidate may specify one set of credential value preferences indicating a preference for a high value for the area of computer science and another set of credential value preferences indicating a preference for a lower value in the area of computer science. The candidate may then obtain talent scores calculated for each of the above-described credential value preferences to determine the effect of changes of credential value preferences on his/her talent score.

In some embodiments, a candidate may change his/her credentials, which the candidate previously specified, to determine the effect of these changes on the candidate's talent score. In this way, the candidate may be able to answer questions such as “How can I get better?” For example, if a candidate is considering obtaining additional computer literacy credentials (e.g., learning to program in another programming language, taking a computer science course, participating in a programming competition, etc.), the candidate may add such a credential to the credentials he/she previously specified in order to ascertain the effect of adding these credentials on his/her talent score. Indeed, if adding a credential (e.g., learning another programming language) substantially changes the candidate's talent score, the candidate may be persuaded to obtain the credential (e.g., to learn the other programming language).

The inventor has also appreciated that candidates may be looking to obtain new credentials in addition to the credentials they already have in order to be more favorably evaluated by employers for jobs. However, a candidate may be faced with many choices of which credential(s) to obtain, but only have the resources to obtain one or a small number of new credentials and/or may be uncertain or unaware of what additional credentials would make the candidate more attractive to potential employers. Such a candidate would benefit from being provided with a recommendation as to which credentials the candidate should obtain in order to appear better suited for a job or a job class.

Accordingly, in some embodiments, a talent scoring system may be configured to recommend to a candidate one or more new credentials that the candidate could obtain to increase his/her talent score. The talent scoring system may evaluate the candidate for a job by calculating the candidate's talent score based on the candidate's credentials and credential value preferences specified for the job. Then, the talent scoring system may calculate the candidate's talent score for each of multiple potential credentials the candidate may obtain as though the candidate had obtained the credential. In this way, the effect of adding each particular credential on the candidate's talent score may be measured. The talent scoring system may recommend that the candidate obtain those credentials which increase his talent score by the greatest amount. Techniques related to providing suggestions to candidates to improve their talent scores and/or make them more attractive to employers are described in further detail below.

In some embodiments, a talent score of a candidate for a job may be calculated based on the candidate's credentials in a primary set of credentials and based on the candidate's credentials in a secondary set of credentials. The primary set of credentials may comprise credentials of primary importance (e.g., to an employer) in evaluating candidates. For example, a primary set of credentials may comprise academic credentials related to a candidate's undergraduate education (e.g., a candidate's undergraduate school(s), degree(s), major(s) and/or minor(s), GPA, class rank, etc.).

As another example, a primary set of credentials may comprise one or more of the candidate's professional credentials, examples of which have been described. The secondary set of credentials may comprise credentials (in areas) of secondary importance (e.g., to the employer) in evaluating candidates. For example, a secondary set of credentials may comprise a candidate's professional credentials, computer literacy credentials, and foreign language credentials. The above examples of primary and secondary credentials are non-limiting and illustrative, as primary and secondary credentials may each comprise any suitable set of one or more credentials and may differ depending on the type of job and/or the particular preferences of a given employer.

Accordingly, in some embodiments, a talent score of a candidate for a job may be calculated at least in part by calculating a primary credentials score based on the candidate's credentials in the primary set of credentials, calculating at least one secondary credential score for each of one or more of the candidate's credentials in a secondary set of credentials, and calculating the talent score based at least in part on the primary credentials score and the secondary credential score(s). The primary credentials score may be further calculated based on credential value preferences indicating at least one preferred value for at least one preferred credential in the primary set of credentials. The secondary credential score(s) may be further calculated based on credential value preferences indicating at least one preferred value for at least one preferred credential in the secondary set of credentials.

In some embodiments, the candidate's primary credentials score may be adjusted based at least in part on the candidate's secondary score(s) to obtain the candidate's talent score. For example, in some embodiments, the candidate's primary credentials score may be increased when at least one of the candidate's secondary score(s) is greater than the candidate's primary credentials score. In this way a candidate's initial evaluation, obtained based on the candidate's primary credentials, may be adjusted based on the candidate's secondary credentials.

In some embodiments, each of a candidate's credentials may be either in the primary set of credentials or in the secondary set of credentials. However, in some embodiments, a candidate may have one or more credentials that are neither in the primary set of credentials nor in the secondary set of credentials. Such a situation may occur when the employer seeks to evaluate candidates based on a particular set of credentials of interest to the employer rather than based on every possible credential that the candidates may possess. For example, an employer may specify the primary set of credentials as including one or more academic credentials and the secondary set of credentials as including one or more computer literacy credentials, but neither set comprises foreign language credentials.

The inventors have further appreciated that employers, in some instances, may specify preferences for a credential that a candidate does not possess, but that this preferred credential may be related to one or more credentials that the candidate does possess. For example, a candidate may have a credential of programming experience in the Java programming language, but an employer's credential value preferences for a job do not specify any preferred values either for this credential or for the area of programming. On the other hand, the employer's credential value preferences may specify a preferred value for the credential area of computer science, which is related to the area of programming and the credential of Java programming experience.

Accordingly, in some embodiments, a candidate's talent score may be calculated at least in part by calculating a score for a credential that the candidate possesses based at least in part on preferred value(s) for another credential that the candidate does not possess (e.g., a credential desired by an employer) and the degree to which the candidate's credential and the other credential are related. The degree to which the candidate's credential and the other credential are related may be obtained by using a credentials graph whose nodes correspond to credentials and the weight of an edge between any two nodes in the graph represent the degree to which the two credentials represented by the two nodes are related. The weight may be used to calculate the score of a credential that the candidate possesses and, in turn, the candidate's talent score. In this way, a candidate's talent score may reflect whether the candidate possesses skills related to those desired by an employer.

As described above, a talent scoring system may be configured to calculate a talent score of a candidate that is indicative of the candidate's suitability for a job (e.g., a quantitative analyst). Additionally or alternatively, a talent scoring system may be configured to calculate a talent score of a candidate that is indicative of the candidate's suitability for jobs in a job category (e.g., finance jobs). Accordingly, credential value preferences may be specified and a talent score may be calculated for a job and/or a job category, as techniques described herein are not limited in this respect. For clarity, some embodiments provided below are described in the context of jobs. However, it should be appreciated that unless indicated otherwise, all references to jobs may also be understood as being references to job categories.

It should be appreciated that the embodiments described herein may be implemented in any of numerous ways. Examples of specific implementations are provided below for illustrative purposes only. It should be appreciated that these embodiments and the features/capabilities provided may be used individually, all together, or in any combination of two or more, as the application is not limited in this respect. Some benefits derived from the inventor's insights may only be realized by virtue of implementation of talent scoring techniques on one or more computers, as such talent scoring, even if in theory possible, would not be practicable or even useable unless performed by one or more computers. Furthermore, some advantages derived from the inventor's innovation result from candidates and/or employers being able to access talent scoring resources over a network (e.g., via web access over the Internet), so that candidates and employers do not need to be proximate one another and such resources are generally available to anyone anywhere. Such advantages of which cannot be exploited using manual approaches. Computer implementation and automation are integral aspects of some embodiments.

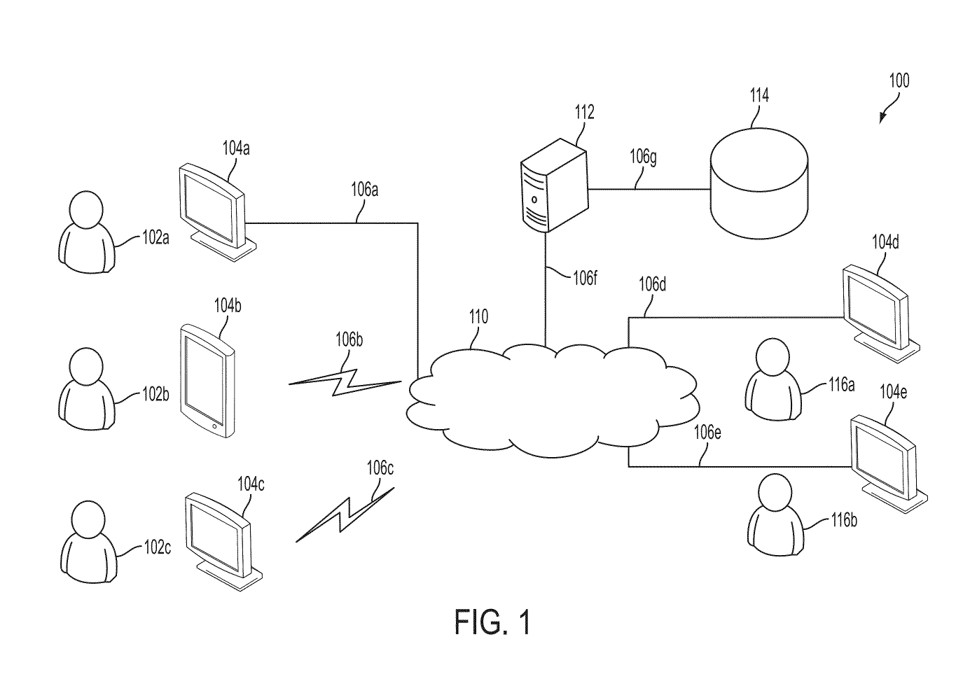

Some embodiments of the present application may operate in the illustrative environment 100 shown in FIG. 1. In the illustrative environment 100, one or multiple candidates (e.g., candidates 102a, 102b, and 102c) may interact with talent scoring system 112 via respective computing devices 104a, 104b, and 104c. Although only three candidates are shown in the illustrative environment 100, one or any suitable number of candidates may interact with talent scoring system 112, as aspects of the disclosure provided herein are not limited in this respect.

In the illustrative environment 100, one or multiple employers (e.g., employers 116a and 116b) may interact with talent scoring system 112 via respective computing devices 104d and 104e. Although only two employers are shown in the illustrative environment 100, one or any suitable number of employers may interact with talent scoring system 112, as aspects of the disclosure provided herein are not limited in this respect. Computing devices 104a, 104b, 104c, 104d, and 104e communicate with talent scoring system via network 110. Network 110 may be any suitable network such as a local area network, a wide area network, a corporate intranet, the Internet, and/or any other suitable network. Computing devices 104a-e are communicatively coupled to network 110 via connections 106a-e, respectively. These connections may be wired, wireless, and/or any other suitable type of connections, as aspects of the disclosure provided herein are not limited in this respect.

Each of computing devices 104a-e may be any suitable type of electronic device which a candidate and/or an employer may use to interact with talent scoring system 112. In some embodiments, one or more of computing devices 104a-e may be a portable device such as a mobile smart phone, a personal digital assistant (PDA), a laptop computer, a tablet computer, or any other portable device that may be used to interact with talent scoring system 112. In some embodiments, one or more of computing devices 104a-e may be a fixed electronic device such as a desktop computer, a server, a rack-mounted computer, or any other suitable fixed electronic device that may be used to interact with talent scoring system 112.

In some embodiments, a candidate (e.g., candidate 102a, 102b, and 102c) may interact with a talent scoring system (e.g., talent scoring system 112) via any suitable application program configured to execute on the candidate's computing device (e.g., computing device 104a, 104b, and 104c). For example, the candidate may interact with the talent scoring system by using a web-browser application program. As another example, the candidate may interact with the talent scoring system by using a stand-alone application program dedicated to providing access to the talent scoring system. Similarly, in some embodiments, an employer (e.g., employer 116a, 116b, etc.) may interact with a talent scoring system via any suitable application program (e.g., web-browser application program, stand-alone application program, etc.) configured to execute on the employer's computing device (e.g., computing device 104d and 104e).

In some embodiments, a candidate may interact with a talent scoring system by providing the talent scoring system with information about him/her. For example, the candidate may provide the talent scoring system with information specifying one or more of the candidate's credentials, examples of which have been previously described. As another example, the candidate may provide the talent scoring system with information specifying credential value preferences associated with one or more jobs. The candidate may specify credential value preferences in order to have the talent scoring system evaluate the candidate's credentials with respect to these credential value preferences.

As yet another example, the candidate may provide the talent scoring system with personal information including, but not limited to, the candidate's name, address, e-mail address, telephone numbers, information identifying the candidate's references, one or more of the candidate's identification numbers (e.g. social security number, driver's license number, passport number, etc.). As yet another example, the candidate may provide the talent scoring system with information indicative of one or more jobs of interest to the candidate (e.g., by specifying one or more employers, identifying one or more jobs, specifying one or more industries, specifying one or more salary ranges, etc.).

As yet another example, the candidate may use the talent scoring system to apply for one or more jobs and provide the talent scoring system with any information needed to do so. The above examples are illustrative and non-limiting examples of information that a candidate may provide to a talent scoring system. A candidate may provide any other suitable information to a talent scoring system, as aspects of disclosure provided herein are not limited by the type of information that a candidate can provide to a talent scoring system.

A candidate may provide a talent scoring system with any of the above-described information via an application program (e.g., web-browser application program, stand-alone application program, etc.) executing on the candidate's computing device. The candidate may provide this information using any suitable user interface (e.g., by filling out one or more forms, uploading one or more files, clicking one or more checkboxes, etc.), or in any other suitable way, as aspects of the disclosure provided herein are not limited by the manner in which a candidate provides information to the talent scoring system.

In some embodiments, a talent scoring system may provide information to a candidate. For example, the talent scoring system may provide the candidate with his/her talent score for one or multiple jobs. As described herein, in some embodiments, the talent scores may be calculated based on the candidate's credentials, values associated with the candidate's credentials, and/or credential value preferences (specified by the candidate or at least one employer) associated with the job or jobs. As another example, the talent scoring system may provide the candidate with information about one or multiple jobs. In the latter case, the talent scoring system may rank information about the jobs based on the respective talent scores and present information about the jobs based at least in part on the ranking.

As yet another example, the talent scoring system may recommend one or more jobs and/or job classes of potential interest to the candidate and provide the candidate with any suitable information to do so. For instance, the talent scoring system may suggest one or more jobs to the candidate for which the candidate has a talent score above a specified threshold (e.g., one or more particular jobs and/or one or more job classes such as an occupation type). Though, the talent scoring system may suggest one or more jobs to the candidate based on any criteria in addition to or instead of talent scores, as aspects of the disclosure provided herein are not limited in this respect.

As yet another example, the talent scoring system may provide a candidate with an indication of how the candidate's talent score for a job compares with talent scores of other candidates who applied for the job. This may be done in any suitable way and, for example, may be done by providing the candidate with an indication of the percentile of his talent score for the job among the talent scores of other candidates whose talent scores were calculated for the job. Additionally or alternatively, the talent scoring system may provide the candidate with the talent scores of other candidates whose talent scores were calculated for the job. In some embodiments, when the talent scoring system has permission to do so, the talent scoring system may provide the candidate with the talent scores and identities of other candidates whose talent scores were calculated for the job. It should be appreciated that a talent scoring system may provide any other suitable information to a candidate, as aspects of disclosure provided herein are not limited by the type of information that a talent scoring system can provide to a candidate.

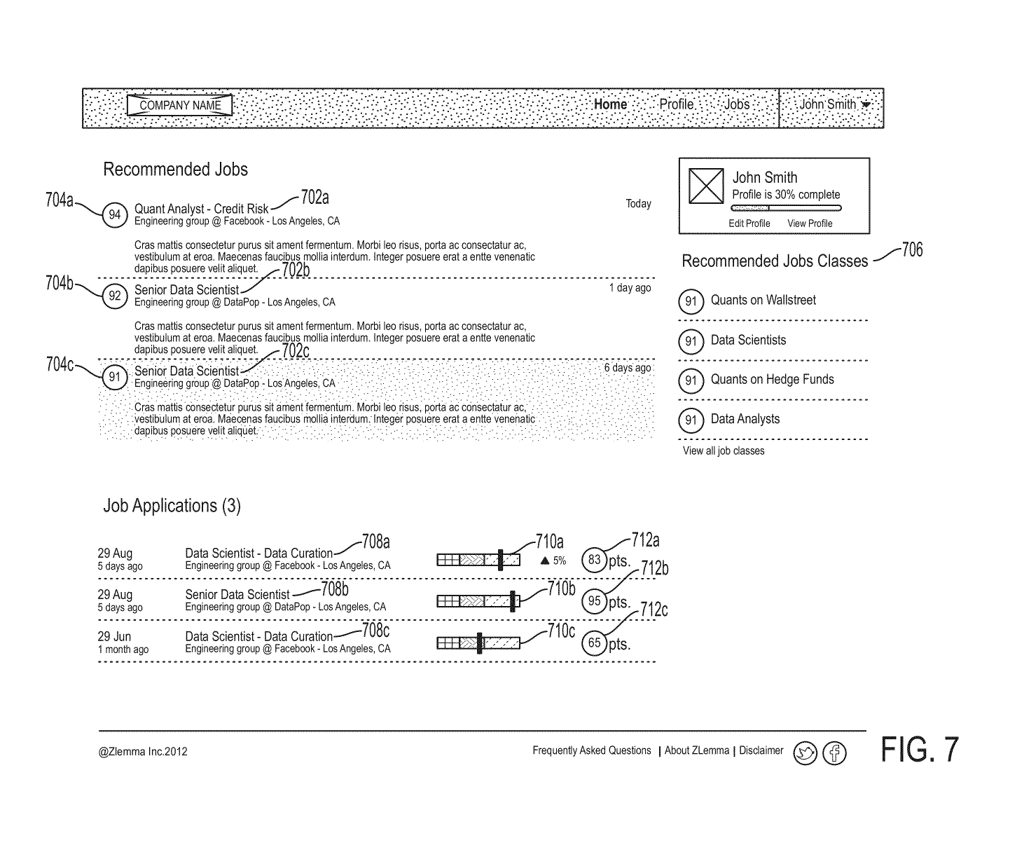

FIG. 7 shows an illustrative, non-limiting example of a user interface 700 that the talent scoring system may provide to a candidate. The user interface 700 provides the candidate with information about three recommended jobs 702a, 702b, and 702c associated with respective talent scores 704a, 704b, and 704c. In user interface 700, information about the recommended jobs is ordered based on the talent scores. The user interface 700 also provides the candidate with four recommended job classes 706. The user interface 700 also provides the candidate with information about jobs 708a, 708b, and 708c, for which the candidate has applied. For each such job, user interface 700 provides the candidate with an indication, via elements 710a, 710b, and 710c, of how the candidate's talent score compares with scores of other candidates who applied for the job.

The user interface 700 also provides the candidate with a talent score (scores 712a, 712b, and 712c) for each of the jobs to which the candidate has applied. It should be appreciated that user interface 700 is merely an illustrative and non-limiting example. For example, although user interface 700 shows three recommended jobs, four recommended job classes and three jobs for which the candidate has applied, the talent scoring system may provide the candidate with any suitable number of talent scores, recommended jobs, recommended job classes, and may allow the candidate to apply for any suitable number of jobs, as aspects of the disclosure provided herein is not limited in this respect.

In some embodiments, an employer may interact with a talent scoring system by providing the talent scoring system with information about one or more jobs for which the employer seeks candidates. The employer may provide the talent scoring system with information about each job such as the job title, job description, job location, and/or any other suitable information about each job. The employer may provide the talent scoring system with credential preferences and/or credential value preferences for one or more job(s), examples of such credential preferences and credential value preferences are described herein. Additionally, the employer may provide the talent scoring system information about the employer (e.g., name of employer, place(s) of business of the employer, information about the employer's business, etc.). An employer may provide any other suitable information to a talent scoring system, as aspects of disclosure provided herein are not limited by the type of information that an employer can provide to a talent scoring system.

An employer may provide a talent scoring system with any of the above-described information via an application program (e.g., web-browser application program, stand-alone application program, etc.) executing on a computing device of the employer. The employer may provide this information using any suitable user interface (e.g., by filling out one or more forms, uploading one or more files, clicking one or more checkboxes, etc.), or any other suitable way, as aspects of the disclosure provided herein are not limited by the manner in which an employer provides information to the talent scoring system.

In some embodiments, a talent scoring system may provide information to an employer. For example, a talent scoring system may provide an employer with a talent score for one or multiple candidates that have expressed interest in and/or applied for a job for which the employer is evaluating candidates. As described herein, in some embodiments, the talent scores may be calculated based on credentials of the candidates, values associated with the candidate's credentials, and/or credential value preferences specified for the job by the employer.

In some embodiments, the talent scoring system may provide an employer with information about one or more candidates in addition to their respective talent score(s). For example, the talent scoring system may provide an employer with information about the credentials and/or credential values of a candidate, when it has permission to do so (e.g., when allowed by the candidate to do so, when the candidate indicates to the talent scoring system that he/she has interest in an employer's job without applying for the job, and/or when the candidate applies for the job). As another example, the talent scoring system may provide an employer with information identifying a candidate (e.g., the candidate's name, the candidate's contact information), when the talent scoring system has permission to do so (e.g., when allowed by the candidate to do so, when a candidate applies for the job, etc.).

When the talent scoring system presents information about multiple candidates to an employer, the talent scoring system may rank information about the candidates based on their talent scores and present information about the candidates in accordance with the ranking. It should be appreciated that a talent scoring system may provide any other suitable information to an employer, as aspects of disclosure provided herein are not limited by the type of information that a talent scoring system can provide to an employer.

The talent scoring system 112 may be configured to perform any of numerous functions for evaluating the suitability of one or more candidates for one or more jobs. Talent scoring system 112 may comprise one or more computing devices (e.g., server(s), rack-mounted computer(s), desktop computer(s), etc.) each comprising one or more processors. The one or more computers forming talent scoring system 112 may be local, distributed (e.g., cloud), and may be connected via any suitable means. Talent scoring system 112 may comprise one or more non-transitory computer readable storage media (e.g., memory and/or one or more other non-volatile storage media) configured to store processor-executable instructions that, when executed by one or more processors of talent scoring system 112, cause the talent scoring system to perform any of numerous functions for evaluating the suitability of one or more candidates for one or more jobs and/or to perform any other techniques or services described herein.

The talent scoring system 112 may be configured to send information to and receive information from users (e.g., one or more candidates, one or more employers, system administrators, etc.) of the talent scoring system. This may be done in any suitable way. As illustrated in computing environment 100, talent scoring system 112 may be configured to send and receive information via network 100 to which it is communicatively couple via connection 106f. Connection 106f is shown as a wired connection, but may be a wireless connection or any other suitable type of connection.

The talent scoring system is communicatively coupled (e.g., via connection 106g which may be a wired, wireless, or any other suitable type of connection or combination of connections) to data store 114 that is configured to store any information that may be used by the talent scoring system. For example, data store 114 may store any information provided to the talent scoring system by one or more candidates, one or more employers, and/or any other entities (e.g., system administrators).

In some embodiments, data store 114 may store information used by the talent scoring system to compute talent score(s) for one or more candidates, but which may not have been provided to the talent scoring system either by the candidates or by employers. In some embodiments, data store 114 system may store information used for assigning values to the credentials of one or more candidates. As one non-limiting example, data store 114 may store information that may be used for assigning values to one or more of the candidate's academic credentials. Such information may include, but is not limited to, one or more rankings of schools (e.g., universities, colleges, vocational schools, etc.), one or more rankings of one or more academic departments (e.g., a ranking of mathematics departments, a ranking of physics departments, a ranking of economics departments, etc.), and information about distributions of grades and/or grade point averages at one or more schools and/or one or more departments (e.g., information indicating that at least a certain percentage of students in a school and/or department have a GPA above a threshold).

As another non-limiting example, data store 114 may store information that may be used for assigning values to one or more of the candidate's computer literacy credentials. For instance, data store 114 may store information used by the talent scoring system to assign a value to a credential of a candidate winning first place in a national programming competition. As another non-limiting example, data store 114 may store information that may be used by the talent scoring system to assign a value to a foreign language credential (e.g., the credential of fluently speaking Japanese). Though, it should be appreciated that the above-described examples of information that may be used for assigning values to the credentials of one or more candidates are illustrative and non-limiting, as data store 114 may store any suitable information that may be used for and/or inform the process of assigning values to credentials (of any suitable type) of one or more candidates.

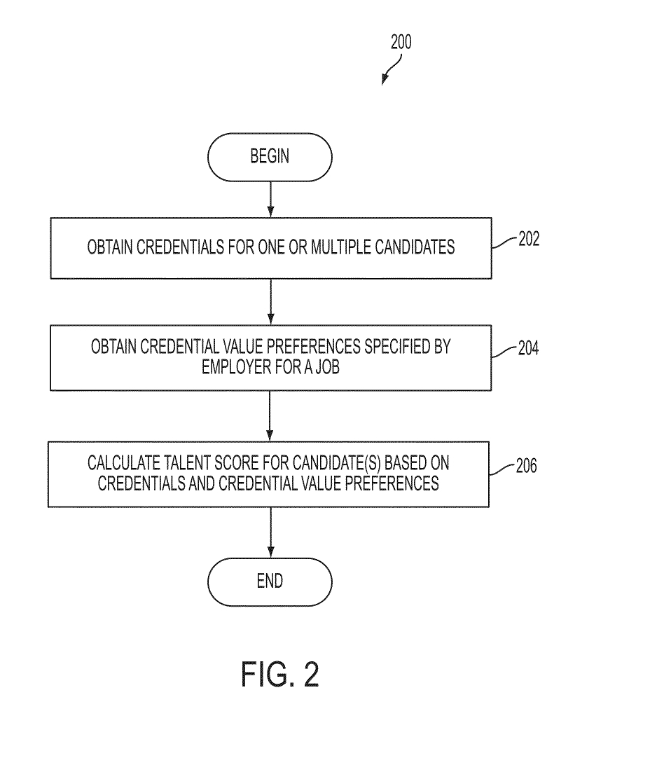

Illustrative computing environment 100 may be used to implement any suitable technique or techniques for evaluating the suitability of one or more candidates for one or more jobs. One such technique is illustrated in FIG. 2, which is a flowchart of illustrative process 200 for calculating a talent score indicative of a candidate's suitability for a job based on credential value preferences specified by an employer for the job, in accordance with some embodiments. Illustrative process 200 may be performed by any talent scoring system and, for example, may be performed by talent scoring system 112, which was previously described.

Illustrative process 200 begins at act 202, where a talent scoring system obtains credentials for one or multiple candidates. As previously described, the talent scoring system may obtain at least some of a candidate's credentials by receiving input from the candidate specifying the candidate's credentials, which that candidate may do in any of numerous ways as described with reference to FIG. 1. Additionally or alternatively, the talent scoring system may obtain at least some of a candidate's credentials from other sources, rather than directly from the candidate. For example, the talent scoring system may obtain at least some of a candidate's credentials from one or more websites and/or web-services (e.g., LinkedIn®, Facebook®, Twitter®, the candidate's webpage or webpages, etc.), one or more recommendations of the candidate by one or more third parties, one or more schools that the candidate is associated with (e.g., is attending or attended), one or more of the candidate's former and/or current employers, and/or any other suitable sources.

In some embodiments, the talent scoring system may obtain credentials for one or multiple candidates by accessing the credentials after they have been previously obtained (e.g., in any of the above-described or other ways such as from a data store that has obtained credential information from submitted resumes or curriculum vitae) and made accessible (e.g., by storing them using one or more non-transitory computer-readable storage media, such as data store 114, accessible by the talent scoring system). As previously described, the talent scoring system may obtain credentials for any suitable number of candidates, as aspects of the disclosure provided herein are not limited in this respect.

After credential(s) of one or more candidates are obtained at act 202, process 200 proceeds to act 204, where the talent scoring system obtains credential value preferences specified by an employer for a job. In some embodiments, the talent scoring system may obtain credential value preferences from the employer, as described with reference to FIG. 1. In some embodiments, the talent scoring system may obtain credential value preferences by accessing the credential value preferences after they have been previously obtained (e.g., in any of the above-described or other ways) and made accessible (e.g., by storing them using one or more non-transitory computer-readable storage media, such as data store 114, accessible by the talent scoring system).

As previously described, credential value preferences may specify one or more credentials that the employer prefers candidates for the job to have as well as one or more preferred value(s) for one or more of the preferred credentials and/or area(s) to which the preferred credentials apply. The preferred values may be indicative of the amount of knowledge and/or skill that the employer prefers the candidate to have in the area(s) of the preferred credential(s).

In some embodiments, an employer's preference for one more values of a candidate's credential may be specified by using one or more weights. The weight(s) may be specified in the credential value preferences. A weight may be assigned to one or more values that a preferred credential may take on. The magnitude of a weight assigned to a particular value of a preferred credential may indicate the extent to which the employer prefers that candidates applying for the job have the amount of knowledge/skill in the area(s) of the preferred credential associated with that particular value. For example, the preferred value may be indicated by the weight having the largest magnitude. Though, it should be appreciated, that an employer's preference for one or more values of a candidate's credential is not limited to being specified by using weights and may be specified in any other suitable way using any suitable type of input (e.g., using language indications such as “less important,” “important,” “very important,” “extremely important,” or similar linguistic indications of the significance an employer attaches to a particular credential and/or credential value), as aspects of the disclosure provided herein are not limited in this respect.

As one non-limiting illustrative example, consider an employer seeking a candidate who is a proficient Japanese speaker. Suppose that, in this example, values of the credential of speaking Japanese are numeric ranging from 0 to 1, with 1 representing the greatest amount of knowledge/skill in speaking Japanese and 0 representing the least amount of knowledge/skill in speaking Japanese (e.g., values of 0-0.5 may indicate some familiarity with speaking Japanese, values of 0.5-0.7 may indicate proficiency in speaking Japanese, and values of 0.8-0.1 may indicate fluency in speaking Japanese. The employer may specify his preferences by providing a weight for each of one or more credential values that they credential of speaking Japanese may take on. For example, as shown in Table 1 below, the employer may assign the weight of 1 to credential values of 0.5, 0.6, and 0.7, the weight of 0.6 to the credential value of 4, and the weights of 0.8 to the credential values of 0.8, 0.9, and 1.0. These weights may indicate the employer prefers candidates that have the credential values of 0.5, 0.6, and 0.7 (e.g., indicative of proficiency in speaking Japanese), prefers candidates that have the credential values of either 0.8, 0.9, or 1 (e.g., indicative of fluency in speaking Japanese) less, and prefers candidates that have the credential value of 0.4 (e.g., indicative of some familiarity in speaking Japanese) the least.

TABLE 1
Example of Specifying Preferred Values
for a Credential Having Numeric Values

| | Value | | | | | | |
|---|---|---|---|---|---|---|---|
| Credential | 0.4 | 0.5 | 0.6 | 0.7 | 0.8 | 0.9 | 1 |
| Japanese | 0.6 | 1 | 1 | 1 | 0.8 | 0.8 | 0.8 |

As previously described, credential values are not limited to being numeric and may be categorical. For instance, in the above-described example, values of the credential of speaking Japanese may be categorical and may take on the values “Some Familiarity,” “Proficiency,” and “Fluency,” and/or any other suitable categorical values. As shown in Table 2A below, the employer may assign a weight for each of one or more of these credential values.

TABLE 2A
Example of Specifying Preferred Values
for a Credential Categorical Values

| | Value | | |
|---|---|---|---|
| Credential | Some Familiarity | Proficiency | Fluency |
| Japanese | 0.6 | 1 | 0.8 |

As also discussed above, an employer (or other party) may indicate the significant of a given credential value using linguistic indicators, as shown in Table 2B below. Such linguistic indicators may then be translated into number or weights, or otherwise converted into a form consistent with the respective technique for computing one or more talent scores.

TABLE 2B
Example of Specifying Significance
of Credential Values Using Language

| | Value | | |
|---|---|---|---|
| Credential | Some Familiarity | Proficiency | Fluency |
| Japanese | Less Important | Most Important | Important |

As another non-limiting illustrative example, an employer may specify one or more preferred values using weights for each of multiple preferred credentials as shown in Table 3 below.

TABLE 3
Example of Credential Value Preferences
Specified for Multiple Credentials

| | Value | | | | | | |
|---|---|---|---|---|---|---|---|
| Credential | 0.4 | 0.5 | 0.6 | 0.7 | 0.8 | 0.9 | 1 |
| Programming | 0.8 | 0.8 | 0.9 | 1 | 0.9 | 0.8 | 0.7 |
| Machine Learning | 0.4 | 0.5 | 0.5 | 0.8 | 0.8 | 1 | 1 |
| Science, Technology, Engineering, | 0.8 | 0.8 | 0.9 | 1 | 1 | 0.9 | 0.8 |
| and Math (STEM) | | | | | | | |

As another non-limiting illustrative example, an employer may specify one or more preferred values using weights for each of multiple values of a candidate's GPA credential as shown in Table 4, below. In this illustrative example, a candidate's GPA credential is assigned a value based on the percentile of his GPA among other candidates attending (or having attended) in the same school or department (though, a candidate's GPA credential may be assigned a value in any other suitable way as aspects of the disclosure provided herein are not limited in this respect). For example, if a candidate's GPA is 3.7 and is higher than the GPA of 80% of other candidates associated with the same school or department, then the candidate's GPA credential may be assigned the value of 80% (or 0.80).

As another example, if a candidate's GPA is 3.7 and is higher than the GPA of 90% of other candidate in the same school or department, then the candidate's GPA credential may be assigned the value of (90% or 0.9). The employer may then specify value preferences for values of the GPA credential by assigning a weight to each of one or more credential values. For example, as shown in the first row of Table 4, an employer may assign weights of 1.0, 0.8, 0.7 and 0.5 to candidate's whose GPA puts them in the 50^{th}-70^{th} percentile, 90^{th} percentile, 100^{th} percentile, and 20^{th} percentile, respectively, of candidates having the same school and/or department.

In some embodiments, the employer may specify different value preferences for a candidate's GPA credential depending on a rank of the candidate's school (e.g., 10^{th} best university, 50^{th} best university, etc.) and/or a rank of the candidate's department (best economics department, 20^{th} best economic department, etc.). Each row of Table 4 illustrates weights indicative of an employer's preferred values for a candidate's GPA credential for a school having a different rank (i.e., 10^{th}, 50^{th}, 100^{th}, and 200^{th} ranked school). Note that the lower the rank of the school, the higher GPA credential values are preferred by the employer.

TABLE 4
Example of Credential Value Preferences
Specified for GPA Credential

| | Value | | | | | | |
|---|---|---|---|---|---|---|---|
| School Rank | 20% | 40% | 50% | 60% | 70% | 90% | 100% |
| 10^{th} | 0.5 | 0.8 | 1.0 | 1.0 | 1.0 | 0.8 | 0.7 |
| 50^{th} | 0.4 | 0.7 | 0.9 | 1.0 | 1.0 | 1.0 | 0.8 |
| 100^{th} | 0.3 | 0.6 | 0.8 | 0.9 | 1.0 | 1.0 | 1.0 |
| 200^{th} | 0.2 | 0.5 | 0.7 | 0.8 | .9 | 1.0 | 1.0 |

In the illustrative examples of Tables 1 and 2, for instance, the employer specified a weight for each of 7 and 3 credential values, respectively. However, it should be appreciated that when the employer is specifying value preferences for a credential using weights, the employer may specify a weight for each of any suitable number (e.g., zero, at least one, at least two, at least three, at least four, at least five, at least ten, at least fifteen, at least twenty, etc.) of values of the credential. For example, in some embodiments, the employer may specify one weight for only one value of the credential (e.g., only one weight (e.g., 1.0) specified for the value of “Proficiency” in Japanese, only one weight specified for the value of 50^{th} percentile for the GPA credential for a 10^{th} ranked school and/or department). Specifying a weight for only one particular value (e.g., “Proficiency”) may be an indication that the employer prefers that candidates have that value more than they have any other value.

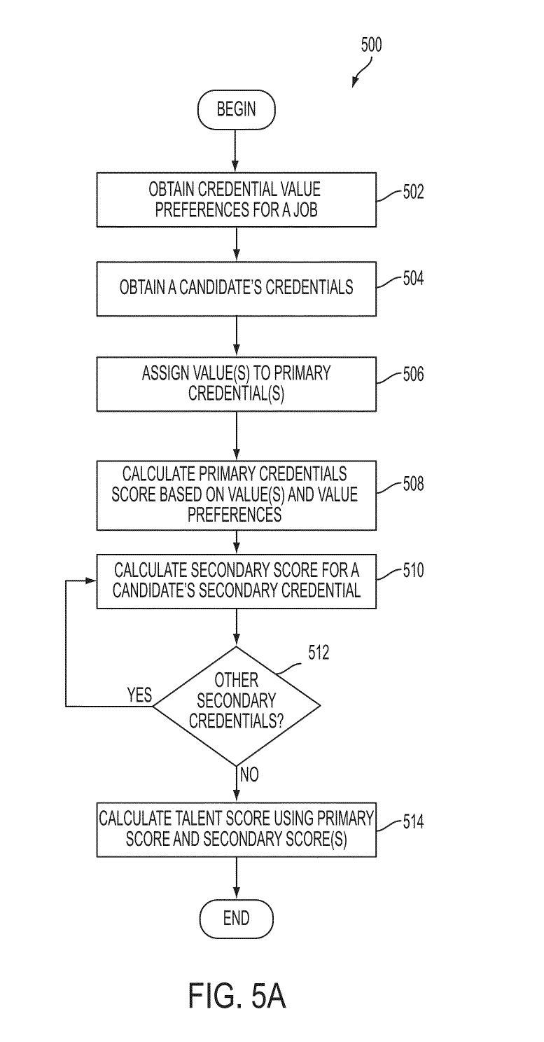

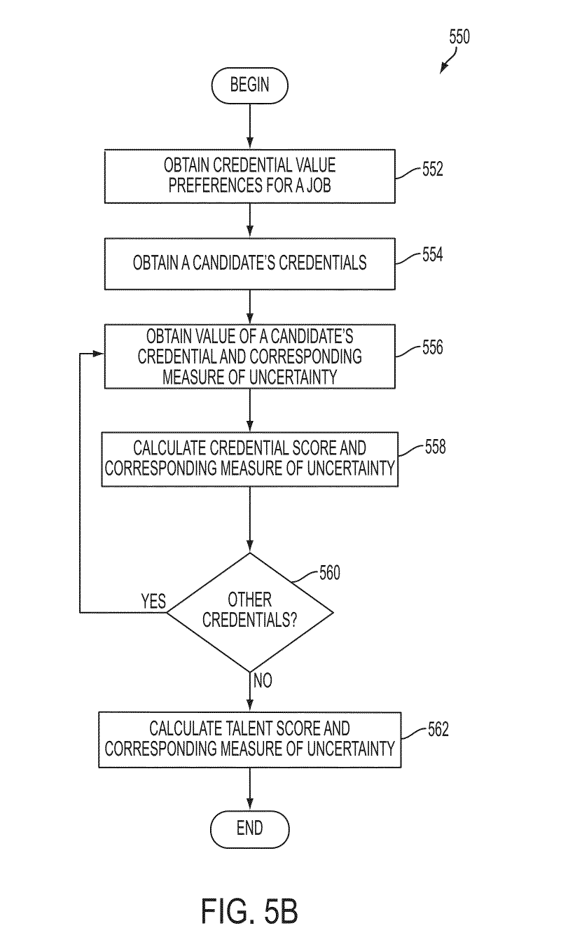

In some embodiments, a credential may take on a greater number of values than the number of values for which the employer specified a weight indicating the extent to which the employer prefers candidates having that credential value. For example, in some embodiments, a GPA credential value may be any integer between 1 and 100 indicating the percentile of the candidate's GPA among candidates associated with the same school or department and the employer may specify a weight for only some of these values. In such embodiments, the talent scoring system may assign a weight for any credential value based at least in part on the weights that were specified for one or more credential values (e.g., by interpolation or any other suitable technique). This is described in greater detail below with reference to FIG. 5A.

As described above, in some embodiments, credential value preferences may not specify any weight (or any information indicating preference or an amount of preference) for any credential value of a preferred credential. In such embodiments, the talent scoring system may use one or more default preference values for that preferred credential. The scoring system may obtain the default preference values in any suitable way and, for example, may access a stored default preference value for the preferred credential based at least in part on the job (e.g., Quantitative Analyst) and/or job category (e.g., Finance). To this end, the talent scoring system may be configured to access one or more default preference values for one or more credentials for each of one or more jobs and or job categories.

In some embodiments, credential value preferences may further specify the relative importance of different credentials and/or types of credentials that a candidate may have. For example, credential value preferences may specify that academic credentials are more important to the employer than publications credentials. As another example, credential value preferences may specify that the credential of “Programming Skills” is more important to the employer than the credential of “Speaking Japanese.” As another example, the credential value preferences may specify that the credential of being a computer science major is more important than the credential of a physics major.

Relative importance of different credentials and/or types of credentials may be specified in any suitable way and, in some embodiments, may be specified by using weights to indicate the degree of importance. For example, as shown in Table 5, weights indicate the relative importance of five types of credentials to an employer.

TABLE 5
Example of Credential Value Preferences Specifying
Relative Importance of Credential Types

| | Credential Type | | | | |
|---|---|---|---|---|---|
| | Profes- | Compe- | Awards and | Computer | |
| | sional | tition | Honors | Literacy | Language |
| Weight | 0.2 | 0.3 | 0.5 | 0.9 | 0.6 |

In another example, as shown in Table 6, weights indicate the relative importance of six different academic credentials, each credential specifying a department the candidate may be associated with.

TABLE 6
Example of Credential Value Preferences Specifying
Relative Importance of Credentials

| | Credential | | | | | |
|---|---|---|---|---|---|---|
| | Computer | Electrical | Mechanical | | Sta- | |
| | Science | Engineering | Engineering | Math | tistics | Physics |
| Weight | 0.9 | 0.9 | 1 | 1 | 0.9 | 0.85 |

In some embodiments, credential value preferences provided by the employer may specify a primary set of credentials of primary importance to an employer and a secondary set credentials of secondary importance to the employer, examples of which have been described. The credential value preferences may further specify at least one preferred value for at least one credential in the primary set of credentials and at least one preferred value for at least one credential in the secondary set of credentials.

Returning to the discussion of process 200, after candidate value preferences are obtained at act 204, the talent scoring system executing process 200 (e.g., talent scoring system 112) calculates a talent score for each of one or multiple candidates based at least in part on their respective credentials (obtained at act 202) and credential value preferences for the job obtained at act 204. This may be done in any suitable way, including the techniques described below in connection with FIG. 5A. The talent score(s) calculated at act 206 may be used to evaluate the suitability of the candidate(s) for the job (e.g., by identifying candidates having their respective talent scores in a range and/or above a threshold, by ranking the candidates based on their talent scores, etc.), and/or used for any other suitable purpose. After the talent score(s) are calculated at act 206, process 200 completes.

It should be appreciated that process 200 is illustrative and that variations of process 200 are possible. For example, although process 200 was described as being used for evaluating the suitability of one or more candidates for a job, process 200 may be adapted to evaluate the suitability of one or more candidates for one or more job categories, examples of which were described. This may be done in any suitable way. For example, in some embodiments, credential value preferences may be obtained for a job category (e.g., from one or multiple employers evaluating candidates for jobs in this category and/or in any other suitable way) and the suitability of each of one or more candidates for the job category may be evaluated based at least in part on the credentials of the candidate(s) and the credential value preferences associated with the job category.

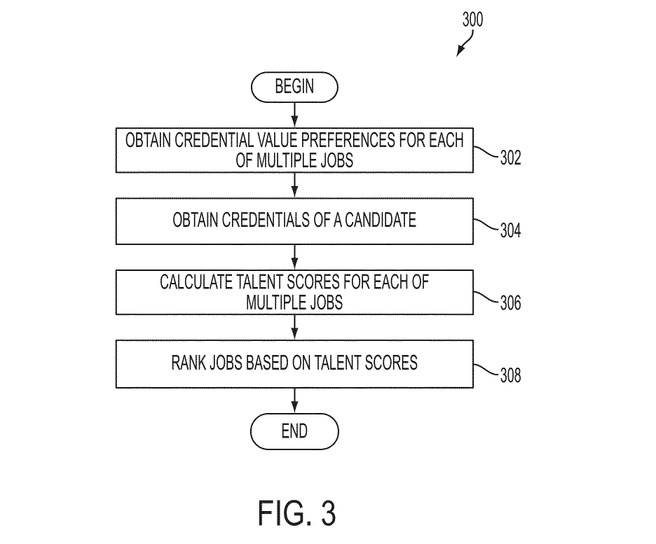

As previously described, a talent scoring system may provide a candidate using the system with his/her talent score calculated for one or multiple jobs and/or job categories. FIG. 3 is a flow chart of an illustrative process 300 for calculating a respective talent score indicative of a candidate's suitability for each of multiple jobs based on credential value preferences associated with each of the multiple jobs. Illustrative process 300 may be performed by any talent scoring system and, for example, may be performed by talent scoring system 112, which was previously described.

Process 300 begins at act 302, where credential value preferences may be obtained for each of one or multiple jobs (e.g., at least two jobs, at least five jobs, at least ten jobs, at least twenty jobs, etc.). Credential value preferences may be obtained in any suitable way including any of the previously described ways. As an illustrative non-limiting example, credential value preferences for a job may be obtained from an employer evaluating suitability of the candidates for the job. As another illustrative non-limiting example, the talent scoring system may store default credential value preferences for the job and/or for a job category of the job and may access the default credential value preferences as part of act 302.

Next, process 300 proceeds to act 304, where a candidate's credentials are obtained. The candidate's credentials may be obtained in any suitable way, including any of the previously described ways.

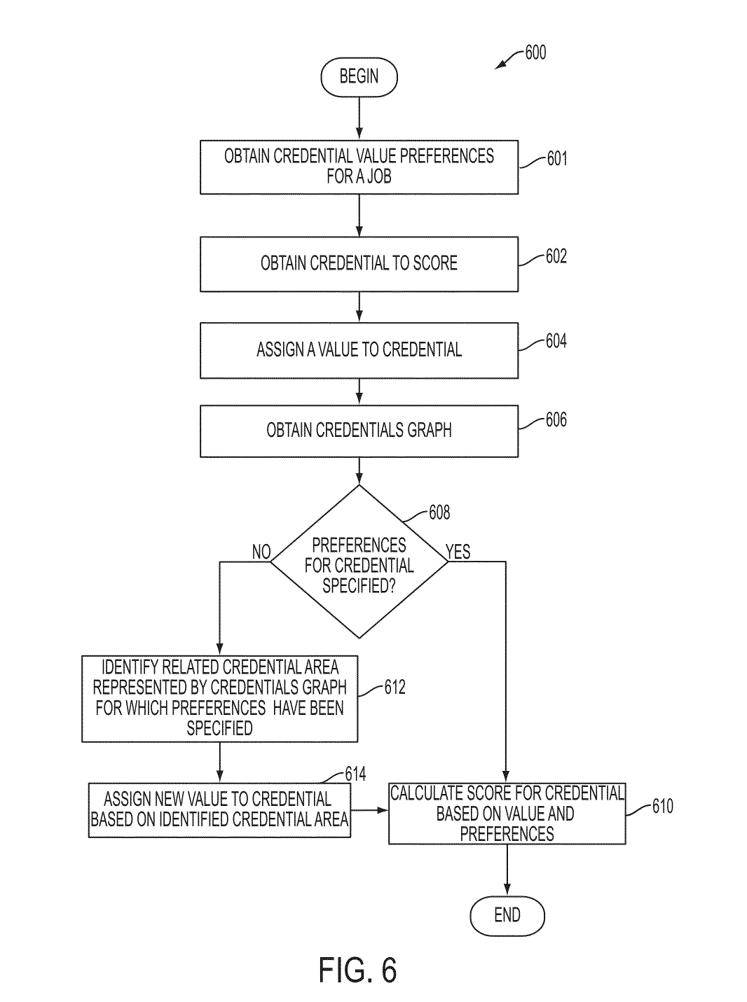

Next, process 300 proceeds to act 306, where the talent scoring system calculates a talent score of the candidate for each of the jobs for which credential value preferences were obtained at act 302. A candidate's talent score for a job may be calculated based at least in part on the candidate's credentials (obtained at act 304) and the credential value preferences associated with the job (obtained at act 302). This may be done in any suitable way, including the techniques described below with reference to FIGS. 5A, 5B, and 6.

Next, process 300 proceeds to act 308, where the talent score(s) may be used to evaluate the suitability of the candidate for the job. The talent score(s) may be used to rank the jobs and rankings (and/or the talent scores themselves) may be used to evaluate the suitability of the candidate for the job(s). This may be done in any suitable and, for example, may comprise identifying jobs (and/or job categories) for which the candidate's score falls in a range and/or above a threshold. After act 308 is performed, process 300 completes.

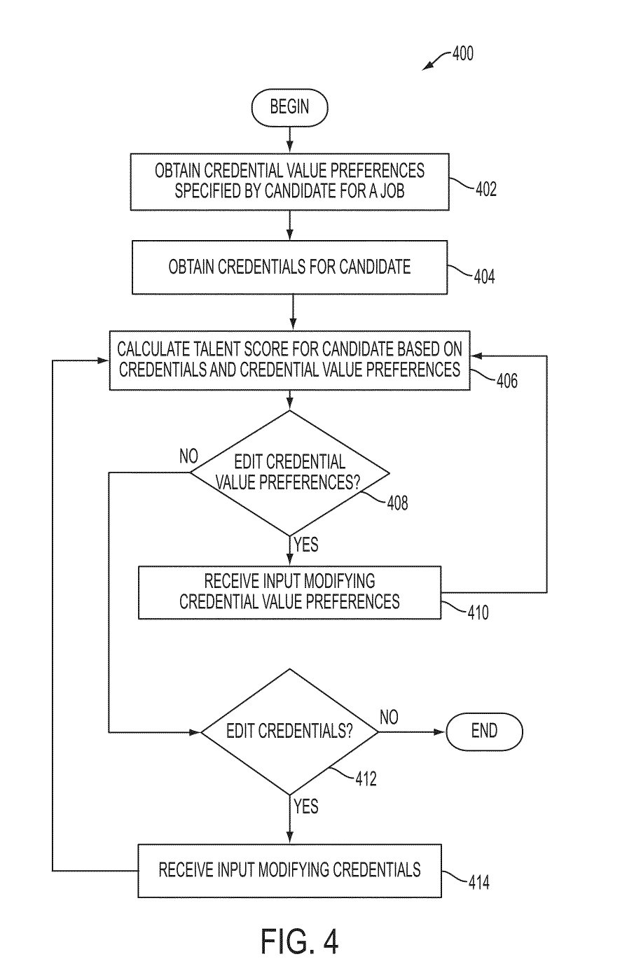

As previously described, in some embodiments, a candidate may specify credential value preferences for a job in order to evaluate himself or herself against the credential value preferences. FIG. 4 is a flow chart of an illustrative process for calculating a talent score indicative of a candidate's suitability for a job based on credential value preferences specified by the candidate for the job. Illustrative process 400 may be performed by any talent scoring system and, for example, may be performed by talent scoring system 112, which was previously described.

Process 400 begins at act 402, where credential value preferences specified by a candidate for a job are obtained. A candidate may specify any of the previously described credential value preferences that may be specified by an employer. The talent scoring system executing process 400 may allow candidates to specify credential value preferences for the job using the same or different user interface(s) as used by employers, as aspects of the disclosure provided herein are not limited in this respect.

Next, process 400 proceeds to acts 404 and 406, where the talent scoring system obtains the candidate's credentials and calculates a talent score of the candidate for the jobs for which credential value preferences specified by the candidate were obtained at act 402. The candidate's credentials may be obtained in any suitable way, including any of the previously described ways. A candidate's talent score for a job may be calculated based at least in part on the candidate's credentials (obtained at act 404) and the credential value preferences associated with the job (obtained at act 402). This may be done in any suitable way, including the techniques described below with reference to FIGS. 5A, 5B, and 6.

Next, process 400 proceeds to decision block 408, where it is determined whether the candidate wishes to edit credential value preferences. This determination may be made in any suitable way. For example, the talent scoring system may prompt the candidate to provide input indicating whether he/she wishes to edit credential value preferences that he/she had specified. As another example, the talent scoring system may receive input from the candidate (e.g., without the candidate being prompted) indicating that he/she wishes to edit credential value preferences.

Responsive to determining, at decision block 408, that the candidate wishes to edit credential value preferences, process 400 proceeds to act 410, where the talent scoring system may receive input specifying how credential value preferences are to be modified. For example, the talent scoring system may receive input indicating different preferred values for one or more preferred credentials. The received input may indicate different preferred values in any suitable way including, but not limited, to specifying one or more weights whose magnitudes indicate preferred values. For instance, the received input may indicate that GPA credentials having values in the range 0.7-0.8 (e.g., in the 70^{th}-80^{th} percentile) are more preferred (e.g., by specifying a weight of 1.0 to these credential values) than GPA credentials having values in the range 0.8-0.9 (e.g., by specifying a weight of 0.9 to these credential values). As another example, the talent scoring system may receive input indicating a different relative importance of different credentials and/or types of credentials that a candidate may have. These are only illustrative examples, however, and credential value preferences may be edited in any suitable way, at act 410, as aspects of the disclosure provided herein are not limited in this respect.

Modifying credential value preferences allows a candidate to determine the effect of such modifications on his/her talent score. Accordingly, after input modifying credential value preferences is received by the talent scoring system at act 410, process 400 returns to act 406, where a talent score of the candidate is calculated based at least in part on the modified credential value preferences.

On the other hand, responsive to determining, at decision block 408, that the candidate does not wish to edit credential value preferences, process 400 proceeds to decision block 412, where it is determined whether the candidate wishes to edit his credentials. This determination may be made in any suitable way. For example, the talent scoring system may prompt the candidate to provide input indicating whether he/she wishes to edit one or more credentials that he/she had specified. As another example, the talent scoring system may receive input from the candidate (e.g., without the candidate being prompted) indicating that he/she wishes to edit one or more credentials.

Responsive to determining, at decision block 412, that the candidate wishes to edit his/her credentials, process 400 proceeds to act 414, where the talent scoring system may receive input specifying how the candidate's credentials are to be modified. For example, the talent scoring system may receive input specifying additional credentials for the candidate (e.g., a new academic credential such as an additional degree, a new computer literacy credential such as learning a new programming language, a new professional credential such as a new internship/job, etc.). As another example, the talent scoring system may receive input removing or modifying an existing credential (e.g., changing the credential of being proficient in a foreign language to the credential of being fluent in the language).

Modifying credentials allows a candidate to determine the effect of such modifications on his/her talent score. For example, the candidate may wish to determine the effect that obtaining one more new credentials (e.g., a master's degree in computer science, learning a new programming language, participating in a programming competition, etc.) may have on his/her talent score for a job (e.g., a computer science job). Accordingly, after input modifying a candidate's credentials is received by the talent scoring system at act 414, process 400 returns to act 406, where a talent score of the candidate is calculated based at least in part on the modified credentials.

On the other hand, responsive to determining, at decision block 412, that the candidate does not wish to modify his/her credential, process 400 completes.

It should be appreciated that process 400 is illustrative and that variations of process 400 are possible. For example, as described above, process 400 allows a candidate to evaluate his/her suitability for a job based on his/her credentials and the credential value preferences specified by the candidate for the job. This may allow a candidate to evaluate his/her suitability for a “mock job”—a job that is not offered or advertised by any particular employer. However, in some embodiments, process 400 may be adapted to allow a candidate to evaluate his/her suitability for a job based on his/her credentials and the credential value preference specified by an employer for the job. In such embodiments, the candidate may not be allowed to modify the credential value preferences specified for the job (by the employer), but may be allowed to modify his/her credentials to determine the effect of such modifications of his/her talent score for the job. In this way, a candidate may be able to determine whether adding one or more new credentials and/or modifying one or more existing credentials may change his/her talent score for a job for which an employer may be hiring.

There are numerous techniques that a talent scoring system may use to calculate a talent score of a candidate for a job based on the candidate's credentials and credential value preferences associated with the job. One such technique is described with reference to FIG. 5A, which is a flow chart of an illustrative process 500 for calculating a talent score indicative of a candidate's suitability for a job at least in part by calculating a first score for at least one of the candidate's primary credentials and a second score for at least of the candidate's secondary credentials. Illustrative process 500 may be performed by any talent scoring system and, for example, may be performed by talent scoring system 112, which was previously described.

Process 500 begins at act 502, where credential value preferences for a job may be obtained. Credential value preferences may be obtained in any suitable way from any suitable source. For example, credential value preferences may be obtained from an employer. As another example, credential value preferences may be obtained from the candidate. As yet another example, at least some (or all) of the credential value preferences may be default value preferences for the job and/or for a job category of the job and may be obtained by the talent scoring system in any suitable way.

In some embodiments, the credential value preferences may specify at least one preferred value for at least one credential in a primary set of credentials. The primary set of credentials may be specified in any suitable way. For example, in some embodiments, the primary set of credentials may be specified by the same party (e.g., an employer or a candidate) that specified the credential value preferences. That party may specify the primary set of credentials as part of credential value preferences or in any other suitable way. As another example, the primary set of credentials may be specified as part of the configuration of the talent scoring system. As previously described, the primary set of credentials may be any suitable set of credentials (e.g., one or more academic credentials, one or more professional credentials, etc.).

In some embodiments, the credential value preferences may specify at least one preferred value for at least one credential in a secondary set of credentials. The secondary set of credentials may be specified in any suitable way including any of the ways in which the primary set of credentials may be specified. As previously described, the secondary set of credentials may be any suitable set of credentials (e.g., awards and honors, professional credentials, computer literacy credentials, foreign language credentials, etc.). In some embodiments, the primary set of credentials and secondary set of credentials do not have any credentials in common (i.e., the set of primary credentials and the set of secondary credentials are disjoint).

After credential value preferences are obtained at act 502, process 500 proceeds to act 504, where credentials of a candidate are obtained. The credentials may comprise one or more credentials in the primary set of credentials. The credentials may also comprise one or more credentials in the secondary set of credentials. The credentials may be obtained in any suitable way, examples of which have been described.

Next, process 500 proceeds to act 506, where the talent scoring system assigns a value to each of one or more of the candidate's credentials in the primary set of credentials. The talent scoring system may assign a candidate's credential (whether a credential in the primary set of credentials or not) a value based on any information, accessible by the talent scoring system, that is indicative of an amount of knowledge/skill implied by the credential to the candidate in the area of the credential.

As one illustrative non-limiting example, the talent scoring system may be configured to access one or more rankings of schools, one or more rankings of one or more academic departments, and/or information about distributions of grades and/or grade point averages at one or more schools and/or one or more departments. The talent scoring system may use such information to assign a value to a candidate's academic credential. For instance, if a candidate has a credential of GPA=3.7 in a school (or department) where 25% of students have a GPA of at least 3.7, the talent scoring system may use this GPA distribution information to assign the value of 0.75 to the credential. If a candidate has a credential of GPA=3.7 in a school (or department) where 10% of students have a GPA of at least 3.7, the talent scoring system may use this GPA distribution information to assign the value of 0.9 to the credential. As previously described, credential values are not limited to being numeric values in the range of 0 to 1 and, in some embodiments, credential values may be numeric values in any suitable range or categorical values, as aspects of the disclosure provided herein are not limited in this respect.

As another illustrative non-limiting example, the talent scoring system may be configured to access information indicative of an amount of knowledge/skill implied by a computer literacy credential. For example, the talent scoring system may access information indicating that placing in the top ten in a national programming competition implies a greater amount of programming skill than does placing in the top ten in state-wide programming competition. Accordingly, the talent scoring system may assign a higher value (e.g., 0.9 or “High”) to the credential of placing in the top ten in a national programming competition than to the credential of placing in the top ten in a state-wide programming competition.

As yet another illustrative non-limiting example, the talent scoring system may be configured to access information indicative of an amount of knowledge/skill implied by a foreign language credential. For example, the talent scoring system may access information indicating that speaking a foreign language fluently implies a greater amount of knowledge/skill in the foreign language, than does being only proficient in speaking the language. Accordingly, the talent scoring system may assign a higher value (e.g., 0.9 or “High”) to the credential of being fluent in a foreign language than to the credential of being only proficient in the foreign language. Though, it should be appreciated that the above-described examples of assigning values to credentials are illustrative and non-limiting, as a talent scoring system may be configured to assign values to any suitable type of credentials in any suitable way.

After the talent scoring system assigns values to one or more of the candidate's credentials in the primary set of credentials, process 500 proceeds to act 508, where the talent scoring system calculates a primary credentials score based at least in part on the values of the candidate's credentials (i.e., the values assigned at act 506) and one or more preferred values for these credentials (i.e., the preferred values specified in credential value preferences for the job obtained at act 502). This may be done in any suitable way.

In some embodiments, the talent scoring system may calculate a primary credentials score based at least in part on a measure of distance between the value(s) of the candidate's primary credential(s) and the corresponding preferred value(s). The smaller the measure of distance between the value(s) of the credential(s) and the preferred value(s), the higher the primary credentials score may be. For example, if the value of a candidate's academic credential (e.g., GPA=3.7) were 0.5 and the preferred value for this credential were specified to be 0.8, then the associated primary credentials score may be lower than the primary credentials score in a case where the value of the candidate's academic credential were closer to 0.8 than 0.5 (e.g., if the value of the candidate's academic credential were 0.6, 0.7, or 0.8).

In some embodiments, the talent scoring system may calculate a primary credentials score by using a mapping from a value of a credential (or values of multiple credentials) to a primary credentials score. The talent scoring system may generate this mapping as part of act 508 or at any time after obtaining credential value preferences at act 502. Accordingly, at act 508, the talent scoring system may generate a mapping (or access a previously generated mapping) from a value of a credential (or values of multiple credentials) to a primary credentials score and may use this mapping to calculate the candidate's primary credentials score.

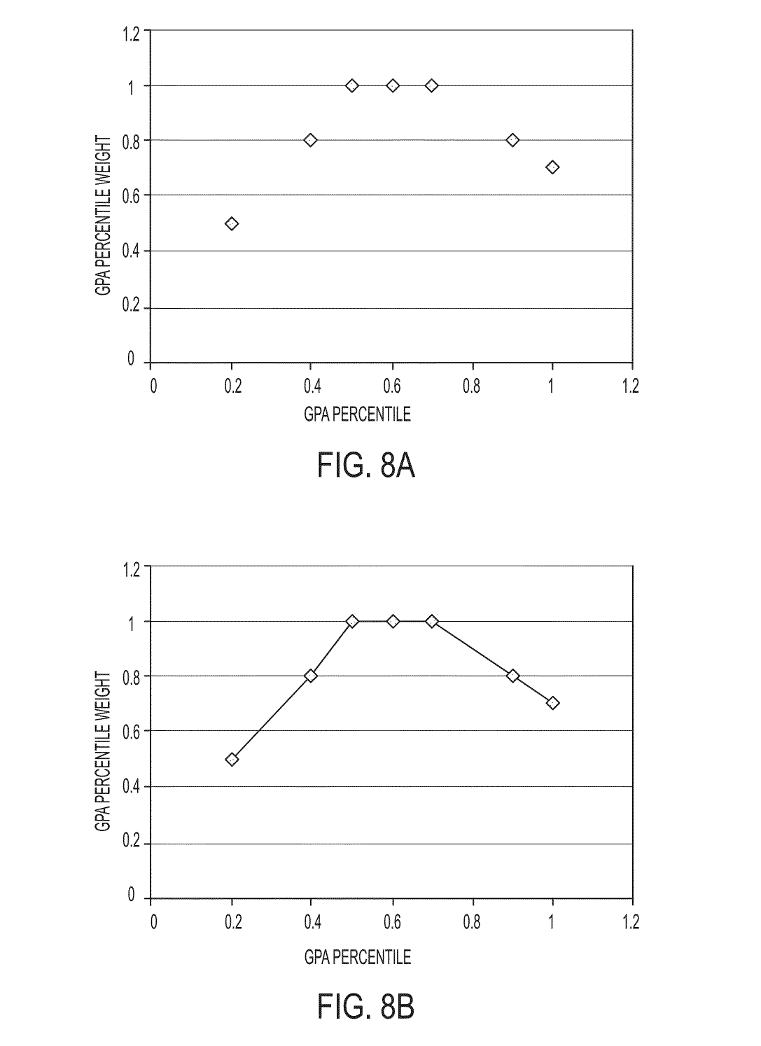

The talent scoring system may generate the mapping at least in part by using the credential value preferences obtained at act 502. This may be done in any suitable way. In some embodiments, when credential value preferences for a credential (or multiple credentials) are specified using one or multiple weights, the talent scoring system may generate the mapping at least in part by using the weights. The mapping may be generated based on the weights in any suitable way such as by using any suitable interpolation technique (e.g., linear interpolation, polynomial interpolation, spline interpolation, wavelet interpolation, etc.) and/or by specifying how the primary credentials score should fall off for as credential values increasingly deviate from a preferred credential value or values. For example, if preferred values for the credential of GPA were specified using weights according to the weights shown in the first row in Table 4 and plotted in FIG. 8A, these weights may be used to construct a mapping from values of a candidate's GPA credential to a score using linear interpolation as shown in FIG. 8B. The piecewise linear mapping illustrated in FIG. 8B may be used to assign a score to any value of a candidate's GPA credential.

As another example, the weights shown in Table 4 may be used to generate a mapping from values of two of the candidate's credentials (i.e., the candidate's school and the candidate's GPA) to a primary credentials score. To calculate the primary credentials score for the candidate in this example, the candidate's credential specifying the candidate's school (or department) may be assigned a value based on its rank (e.g., 10^{th} best school/department, 50^{th} best school/department, etc.) and the candidate's GPA may be assigned a value based on the distribution of GPAs at the candidate's school (or department). The mapping may then be used to determine a score for the values of the candidate's school and GPA credentials.

In some embodiments, the mapping may be scaled such that the maximum primary credentials score may be bounded from above and/or below so that there may be a maximum and/or minimum primary credentials score that may be obtained by using the mapping. For example, the mapping illustrated in FIG. 8B may be scaled by 0.75 (e.g., by multiplying every weight by 0.75) such that the maximum primary credentials score that may be obtained by using the mapping is 0.75.

As may be appreciated from the foregoing examples, the talent scoring system may generate a mapping from values of any suitable number of credentials in a primary set of credentials (e.g., at least one, at least two, at least three, at least four, at least five, etc.) to a primary credentials score. It should also be appreciated that a mapping from a credential value (or from values of multiple credentials) to a primary credentials score may be generated from any suitable number of weights (one, at least two, at least five, at least ten, etc.), as aspects of the disclosure provided herein are not limited in this respect.

In the above-described examples, the primary credentials score was shown to be a value between 0 and 1. However, the primary credentials score may be a numeric value in any suitable numeric range, as aspects of the disclosure provided herein are not limited in this respect.

After the primary credentials score for the candidate is calculated at act 508, process 500 proceeds to act 510, where the talent scoring system calculates a secondary score for a candidate's credential in the secondary set of credentials. The secondary score may be calculated in any suitable way. In some embodiments, the secondary score for a credential in the secondary set of credentials may be calculated in a manner analogous to how the primary credentials score was calculated. That is, the secondary score may be calculated by: (1) assigning a value to the credential and (2) calculating the secondary score based on the value assigned to the credential and at least one preferred value for the credential, as specified in the credential value preferences obtained at act 502. The talent scoring system may assign a value to the credential using any of the techniques described above with reference to act 506 or in any other suitable way. The talent scoring system may calculate the secondary score based on the value and at least one preferred value for the credential using any of the techniques described above with reference to act 508 (e.g., by using a mapping from value of the credential to the secondary score, the mapping generated at least in part by using the at least one preferred value for the credential). The above-described and other techniques for calculating a secondary score are further described below with reference to FIG. 6.

After a secondary score is calculated for a candidate's credential in the secondary set of credentials, process 500 proceeds to decision block 512, where it is determined whether the candidate has any other credentials in the secondary set of credentials for which a score has not been calculated. If it is determined that the candidate has at least one other credential in the secondary set of credentials for which a score has not been calculated, process 500 returns, via the YES branch, to act 510 where a score is calculated for the other secondary credential. Accordingly, process 500 calculates a secondary score for each of the candidate's credentials in the secondary set of credentials. Thus, a talent scoring system may calculate one or multiple secondary scores for a candidate.

Responsive to determining, at decision block 512, that the candidate has no other credentials in the secondary set of credentials for which a secondary score is to be calculated, process 500 proceeds to act 514, where a talent score for the candidate is calculated. The talent scoring system may calculate a score for the candidate based at least in part on the candidate's primary credentials score (calculated at act 508) and one or more secondary scores (calculated at act 510).

In some embodiments, the talent scoring system may calculate the candidate's talent score as a result of increasing the candidate's primary credentials score based at least in part on the candidate's secondary score(s). The candidate's primary credentials score may be increased when at least one of the candidate's secondary score(s) is greater than the candidate's primary credentials score. When there is no secondary score greater than the primary credentials score, the talent scoring system may determine the candidate's primary credentials score to be the candidate's talent score. On the other hand, when there is a secondary score (secondary score “A”) greater than the primary credentials score, the primary credentials score may be increased based on the secondary score to produce a first intermediate score having a value between the primary credentials score and the secondary score. When there is no other secondary score greater than the first intermediate score, the talent scoring system may determine the first intermediate score to be the candidate's talent score. On the other hand, when there is another secondary score (secondary score “B” different from secondary score “A”) greater than the first intermediate score, the first intermediate score may be increased based on the other secondary score to produce a second intermediate score having a value between the first intermediate score and the other secondary score (i.e., secondary score “B”). When there is no secondary score (other than secondary scores “A” and “B”) greater than the second intermediate score, the talent scoring system may determine the second intermediate score to be the candidate's talent score. Otherwise, the above described process continues by computing successively increasing intermediate scores until no previously unused secondary score greater than the last computed intermediate score remains. The talent scoring system may determine the last computed intermediate score to be the candidate's talent score.

As described above, the first intermediate score may be calculated based on the primary credentials score and a secondary score greater than the primary credentials score. This may be done in any suitable way. For example, the first intermediate score may be calculated as an affine combination of the primary credentials score and the secondary score according to Pa+S(1−α), where P is the primary credentials score, S is the secondary score and the weighting factor α is a real number between 0 and 1. The weighting factor α may be set in any suitable way and, in some embodiments, may be set based on the relative importance of the credential associated with the secondary score S. As previously described, credential value preferences may specify the relative importance of different credentials that a candidate may have and, in some embodiments, the relative importance of different credentials may be specified by using weights (see e.g., Table 5). Accordingly, the weighting factor α may be set to be (or may be set based on) a weight specifying the relative importance of the credential associated with the secondary score S.

It should be appreciated that the above-described way of calculating a talent score based on the primary credentials score and the secondary score(s) is illustrative and that a candidate's talent score may be calculated based on his/her primary credentials score and secondary score(s) in any other suitable way. After the candidate's talent score is calculated at act 514, process 500 completes.

As previously described, a talent score computed according to some embodiments described herein may have some amount of uncertainty resulting from, among other reasons, the fact that the credentials used to calculate the talent score may not be quantifiable with absolute certainty. As a result, a measure of uncertainty may be computed for a talent score based on the level of corresponding uncertainty. A measure of uncertainty refers herein to any number, interval or range (discrete or continuous) associated with a talent score (or a credential value) that is indicative of a level of certainty/uncertainty associated with the talent score or credential value. For example, the measure of uncertainty may be a symmetric or asymmetric range about the talent score, or may be an independent number reflecting the certainty/uncertainty of the talent score (e.g., a number between 1 and 100, a percentage, or any other number reflecting certainty/uncertainty). A measure of uncertainty represented as an interval may also be referred to herein as a confidence interval. FIG. 5B is a flow chart of an illustrative process 550 performed by a talent scoring system for calculating a talent score indicative of a candidate's suitability for a job and an associated measure of uncertainty, in accordance with some embodiments. Illustrative process 550 may be performed by any talent scoring system and, for example, may be performed by talent scoring system 112, which was previously described. Process 550 begins at act 552, where the talent scoring system obtains credential value preferences for a job. This may be done in any suitable way, examples of which have been described.

Next, process 550 proceeds to act 554, where the talent scoring system obtains the candidate's credentials. The credentials may comprise any suitable number of credentials of any suitable type. For example, the credentials may comprise one or more credentials in a primary set of credentials and/or one or more credentials in a secondary set of credentials (e.g., as described with reference to FIG. 5A).

Next, process 550 proceeds to act 556, where the talent scoring system obtains a value of and/or assigns a value to one of the candidate's credentials, and provides a measure of uncertainty corresponding to the obtained and/or assigned value. The talent scoring system may assign a value to the credential in any suitable way and, for example, may assign a value to the credential based on information indicative of an amount of knowledge/skill implied by the credential to the candidate in the area of the credential, as previously described with reference to act 506 of process 500.

In some embodiments, the measure of uncertainty corresponding to the value of the credential may be an interval. The interval may be a contiguous interval represented by a minimum value and a maximum value. An interval representing a measure of uncertainty corresponding to a value of the credential may include the value of the credential such that the value of the credential is greater than (or equal to) the minimum value of the interval and smaller than (or equal to) the maximum value of the interval. The interval may be symmetric about the value of the credential, but is not limited to being symmetric. For example, in some instances, the interval representing a measure of uncertainty corresponding to a value of the credential may not be centered on the value of the credential (e.g., the difference between the minimum value of the interval and the value of the credential is not the same as the difference between the maximum value of the interval and the value of the credential). It should be appreciated that the measure of uncertainty corresponding to a credential value is not limited to being an interval and may be any other suitable measure of uncertainty. For example, in some embodiments, the measure of uncertainty may be probabilistic and may be specified via one or more distributions and/or other statistical quantities.

The measure of uncertainty corresponding to a value of a candidate's credential may be obtained in any of numerous ways. As one non-limiting example, the measure of uncertainty may be calculated based, at least in part, on the magnitude of the credential value. For instance, when the measure of uncertainty is an interval, that interval may be wider when the value of the credential is smaller (signifying less certainty in the value of the credential) and narrower when the value of the credential is larger (signifying greater certainty in the value of the credential).

As another non-limiting example, the measure of uncertainty for a value of a credential may be calculated based, at least in part, on the type of the credential. For example, the measure of uncertainty for an academic credential of having a degree from a particular university may be calculated on the variance in the rankings (e.g., as obtained from various published rankings of universities) of that university among different rankings of universities, whereas the measure of uncertainty for the credential of computer programming proficiency may be calculated based on the number of programming competitions a candidate has entered and placed in. As a result, the measure of uncertainty for a value of one credential (e.g., a degree from a particular university) may be different from the measure of uncertainty for a value of another credential (e.g., proficiency in a computer programming language) even if the values of these credentials are the same (e.g., both values are 0.9).

As yet another non-limiting example, the measure of uncertainty for a credential value may depend on (e.g., may be based on the reliability of) the source of data from which the credential value was obtained. For example, the uncertainty interval of a value associated with the credential of a test score may be narrower (indicating a higher level of certainty) for a standardized national test (e.g., SAT, MCAT, GRE, etc.) than for a statewide or local test. As another example, the measure of uncertainty (e.g., an interval) of a value associated with the credential of a mathematics competition may indicate a higher level of certainty in the value of the credential for an established competition (e.g., the Putnam mathematics competition) than for a less established (e.g., local) mathematics competition.

As yet another non-limiting example, the measure of uncertainty for a credential value may depend on whether or not particular data was or was not available for use in calculating the value of the credential. For example, as described above, the value of the credential that a candidate has a 3.7 GPA may be calculated based, at least in part, on the class rankings (data indicating how many other people at the candidate's school have a GPA of 3.7 or higher). The confidence in that value may be higher than the confidence in a value of the same GPA credential if it was calculated without any class ranking information available.

Next, process 550 proceeds to act 558, where the talent scoring system calculates a score for the credential (whose value was obtained at act 556) and a corresponding measure of uncertainty. The score for the credential may be obtained based, at least in part, on the credential value preferences obtained at act 552 and the value for the credential obtained at act 556. This may be done in any of the ways previously described with reference to act 508 of process 500 or in any other suitable way.

The measure of uncertainty corresponding to the score of the credential may also be calculated based, at least in part, on the credential value preferences obtained at act 552 and the value for the credential obtained at act 556. When the measure of uncertainty for the value of a credential is an interval represented by a minimum value and a maximum value, the measure of uncertainty for the score of the credential may be obtained by calculating a score for the minimum value to obtain a minimum score and a score for the maximum value to obtain a maximum score. The minimum and maximum scores so obtained then define the interval representing the measure of uncertainty for the score of the credential. A score may be calculated for the minimum value of the interval and the maximum value of the interval in the same way as for the value of the credential, in some embodiments.

Next process 550 proceeds to decision block 560, where it is determined whether to calculate a score and/or a measure of uncertainty for any other credentials of the candidate. This determination may be made in any suitable way, as aspects of the disclosure provided herein are not limited in this respect. For example, if the candidate has one or more credentials that have not been scored, it may be determined to obtain and/or assign value(s) and score(s) for the unscored credential(s). As another example, if the employer has specified credential value preferences for one or more credentials that have not been scored, the talent scoring system may decide to obtain and/or assign value(s) and score(s) for these unscored credential(s). When it is determined to obtain value(s) and score(s) for one or more unscored credentials, process 550 returns to act 556 so that acts 556 and 558 may be repeated. On the other hand, when it is determined that no other credentials need to be scored, process 550 proceeds to act 562, where a talent score is calculate for the candidate.

A candidate's talent score may be computed based on scores obtained for the candidate's credentials. This may be done in any suitable way and, in some embodiments, may be done as previously described with reference to act 514 of process 500. For example, the talent score may be calculated as a weighted sum (e.g., an affine combination) of credential scores. Similarly, the measure of uncertainty for the talent score may be calculated as a weighted sum (e.g., an affine combination) of the measures of uncertainty for the scored credentials. For example, when the talent score is a calculated as a weighted sum of credential scores for N credentials (where N is any integer greater than or equal to 2) and each of the credential scores is associated with a respective interval representing the measure of uncertainty associated with the credential score, a minimum talent score value may be calculated as a weighted (e.g., affine) sum of minimum values of the intervals and a maximum talent score value may be calculated as a weighted (e.g., affine) sum of the maximum values. The minimum and maximum talent scores so obtained may represent the measure of uncertainty associated with the candidate's talent score. After the talent score and corresponding measure of uncertainty are calculated, at act 562, process 550 completes. As a result, a talent score and an accompanying measure of uncertainty may be provided for a given candidate, which process may be repeated for any number of candidates.

As previously described, credential value preferences associated with a job may not specify any preferred values for a particular credential of a candidate or its area, but may specify one or more preferred values for another related credential area. Accordingly, in some embodiments, a candidate's talent score may be calculated at least in part by calculating a score for the candidate's credential based at least in part on the preferred value(s) for another related credential area and the degree to which the candidate's credential and the other credential area are related. One example of such an approach is illustrated in FIG. 6, which is a flow chart of an illustrative process 600 for calculating a score for a credential based on value preferences specified for the credential or value preferences specified for another credential area related to the area of the credential.

Illustrative process 600 may be performed by any talent scoring system and, for example, may be performed by talent scoring system 112, embodiments of which were previously described. Illustrative process 600 may be performed to calculate a score for a candidate's credential as part of calculating the candidate's talent score. For example, illustrative process 600 may be used to calculate a secondary score for a candidate's credential in the secondary set of credentials (e.g., as part of act 510 of process 500) and/or to calculate the primary credentials score for the candidate (e.g., as part of acts 506-508 of process 500).

Process 600 begins at act 601, where the talent scoring system obtains credential value preferences for a job. This may be done in any suitable way, examples of which have been described.

Next, process 600 proceeds to act 602, where the talent scoring system obtains a candidate's credential for which the talent scoring system is to calculate a score. The credential may be a credential in the primary set of credentials or a credential in the secondary set of credentials. The credential may be any suitable type of credential indicative of knowledge/skill in any suitable area. The credential may be obtained in any suitable way by the talent scoring system, examples of which have been described.

After obtaining the credential at act 602, process 600 proceeds to act 604, where the talent scoring system assigns a value to the credential. The talent scoring system may assign a value to the credential in any suitable way and, for example, may assign a value to the credential based on information indicative of an amount of knowledge/skill implied by the credential to the candidate in the area of the credential, as previously described with reference to act 506 of process 500.

Next, process 600 proceeds to act 606, where the talent scoring system accesses a credential's graph representing relationships among credentials and/or credential areas. The credentials graph may be encoded in at least one data structure that may comprise any data necessary for representing the credentials graph and, for example, may comprise any parameters associated with the credentials graph. The data structure(s) encoding the credentials graph may be stored on any non-transitory computer-readable storage medium or media accessible by the talent scoring system (e.g., data store 114). Accordingly, the talent scoring system may access the credentials graph by accessing the data structure(s) encoding the credentials graph.

The credentials graph may comprise a set of nodes (vertices) and a set of edges connecting nodes in the set of nodes. The credentials graph may be directed or undirected. Each node may represent one or multiple credential areas and/or credentials. An edge between two nodes indicates that the credential areas and/or credentials represented by the two nodes are related. Each edge may be associated with a weight. Accordingly, the data structure(s) representing the graph may encode the graph's vertices, edges, and weights. Any of numerous data structures for encoding graphs may be used to encode the credentials graph, as aspects of the disclosure provided herein are not limited in this respect.

The credentials graph may comprise any suitable number of edges connecting the nodes in any suitable way. For example, in some embodiments, the graph may include or be a hierarchical graph without loops (e.g., a tree). In other embodiments, the graph may contain loops and, in some instances, may be a fully connected graph. In some embodiments, the credentials graph may be a complete graph, whereby every pair of nodes is connected by an edge (or two edges, when the graph is a directed graph).

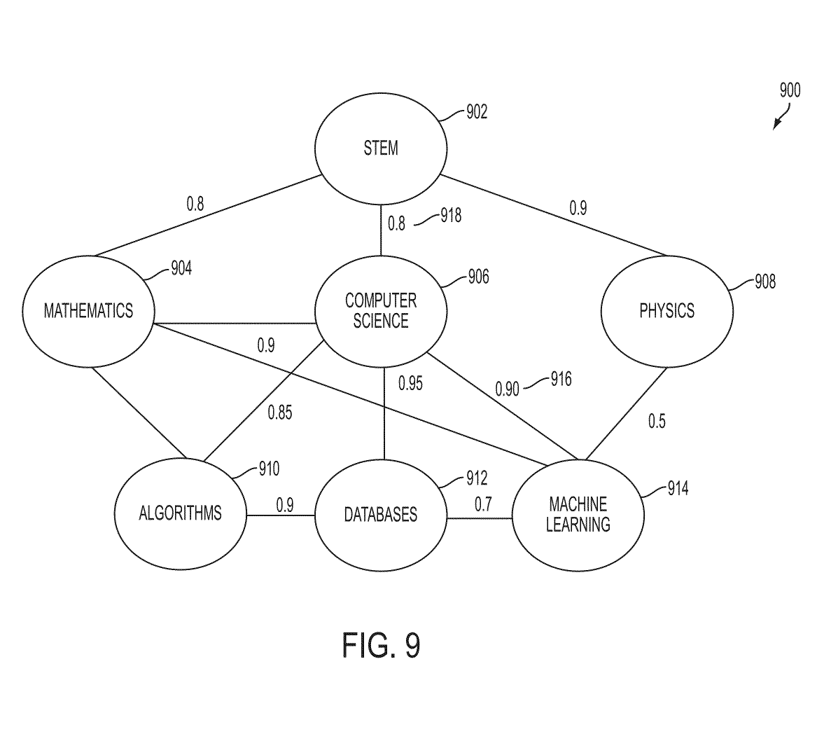

FIG. 9 shows an illustrative credentials graph 900 of credential areas 900. In this example, the node 902 of the graph represents the Science, Technology, Engineering, and Mathematics (STEM) credential areas. Nodes 904, 906, and 908, which are connected to node 902, represent the credential areas of mathematics, computer science, and physics, respectively. Nodes 910, 912, and 914 represent the credential areas of algorithms, databases, and machine learning, respectively. Node 914 representing machine learning is connected to node 906 (“computer science”), node 904 (“mathematics”), and node 908 (“physics”). It should be appreciated that credential graph 900 is only illustrative and shows a small number of nodes for clarity. A credential graph may be of any suitable size comprising any suitable number of nodes representing any suitable number of credential areas, as aspects of the disclosure provided herein are not limited in this respect. It should also be appreciated that although the illustrated credentials graph represents only STEM credential areas, a graph credential areas may represent any suitable types of credential areas (e.g., humanities), as aspects of the disclosure provided herein are not limited in this respect.

In some embodiments, where the credentials graph is a directed graph, a directed edge from a first node to a second node may indicate that the credential area represented by the second node is a sub-area of the credential area represented by the first node. In this way, the credentials graph may represent hierarchical relationships between credential areas.

Each edge in the credentials graph may be associated with a weight. The weight may be indicative of the amount of knowledge/skill in the credential area(s) represented by a first node that is implied by a given amount of knowledge/skill in the credential area(s) represented by a second node connected to the first node. For example, the amount of knowledge/skill in the area of computer science implied by a given amount of knowledge/skill in the area of machine learning is a fraction of that given amount, the fraction being specified by the weight. Consider an example in which a candidate has a credential in the area of machine learning (e.g., a course in machine learning) and the credential is assigned a value of 0.8, which is indicative of an amount of knowledge/skill the candidate has in the area of machine learning. Using the credentials graph, this same credential may be assigned a value of 0.8*0.9=0.72 (weight 916=0.9), which is indicative of the amount of knowledge/skill the candidate has in the area of computer science. Using the credentials graph 900 again, this same credential may be assigned a value of 0.8*0.9*0.8=0.576 (weight 918=0.8), which is indicative of the amount of knowledge/skill the candidate has in the STEM credential areas.

As should be appreciated from the foregoing, the credentials graph may be used to assign a value to a credential for each of multiple areas in represented in the graph. A credential (e.g., a class in machine learning) may be assigned a value for its corresponding area (e.g., machine learning) using any suitable technique and a value for each of one or more areas related to the corresponding area (e.g., computer science, mathematics, STEM, etc.). The value(s) for the related area(s) may be calculated at least in part by using weights specified in the hierarchy of credential areas. This may be advantageous when value preferences are specified only for some credential areas (e.g., computer science), but not others (e.g., machine learning), as described in further detail below.

After the talent scoring system accesses the credentials graph in act 606, process 600 proceeds to decision block 608, where it is determined whether credential value preferences have been specified for the credential obtained at act 602. Responsive to determining that credential value preferences have been specified for the credential (e.g., for the credential of having a course in machine learning) and/or for the area of the credential (e.g., the credential area of machine learning), process 600 proceeds, via the “YES” branch, to act 610, where the talent scoring system calculates a score for the credential based on the specified credential value preferences and the value assigned to the credential at act 604. This may be done in any of the ways previously described with reference to act 508 of process 500 or in any other suitable way. After the score is calculated for the credential at act 610, process 600 completes.

On the other hand, responsive to determining that credential value preferences have not been specified either for the credential or for the area of the credential, process 600 proceeds, via the “NO” branch, to act 612. At act 612, the talent scoring system identifies a related credential area in the credentials graph that is related to the area of the credential obtained at act 602 and for which credential value preferences have been specified. The related credential area may be identified by using the credential value preferences (obtained at act 601) and the credentials graph (accessed at act 606). A credential area in the graph may be related to the credential obtained at act 602 if there is a path from that credential area to the area of the credential obtained at act 602 (in a complete graph, each path would consist of a single edge). For instance, in the example of FIG. 9, the credential areas of “STEM,” “computer science,” and “mathematics” are related to the credential of a course in machine learning because there is a path in the graph from the nodes representing these areas to the node representing machine learning, which is the area of the credential of a course in machine learning.

After the related credential area is identified at act 612, process 600 proceeds to act 614, where the talent scoring system assigns a new value to the credential obtained at act 602 so that this new value is indicative of the amount of knowledge/skill the credential implies the candidate has in the credential area identified at act 612. The new value may be computed by discounting the value of the credential, computed at act 604, by weights along the path from the credential area identified at act 612 to the area of the credential. For example, if the value of 0.8 were assigned to the credential of a course in machine learning at act 604, and the credential area STEM were identified at act 612, then the new value may be computed as 0.8*0.9*0.8=0.576 using weights 916 and 918 in illustrative credentials graph 900.

After the new value is calculated for the credential obtained at act 602, process 600 proceeds to act 610, where the credential value preferences (obtained at act 601) and the new value are used to calculate a score for the credential. After the score is calculated, process 600 completes.

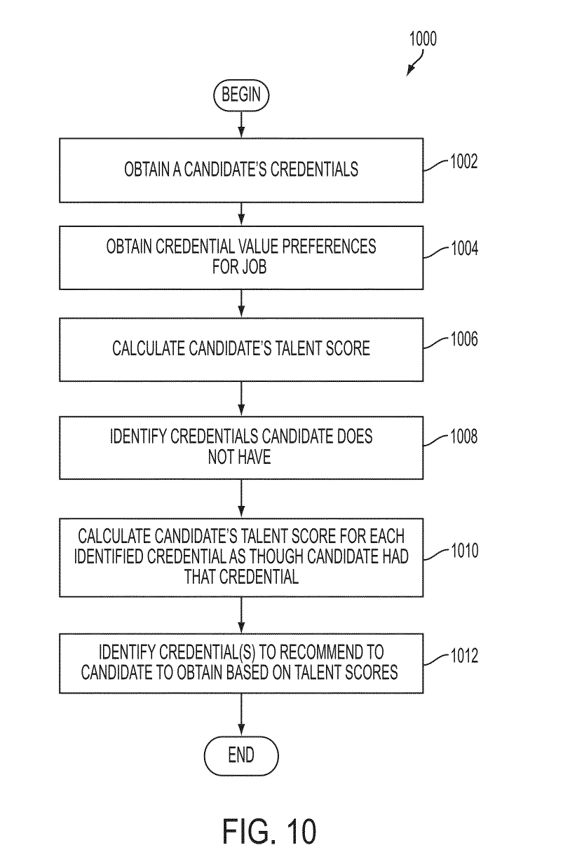

As has been previously discussed, a talent scoring system may be configured to recommend to a candidate one or more new credentials that the candidate may wish to obtain. FIG. 10 shows is a flowchart of an illustrative process 1000 for recommending credentials to a candidate. Illustrative process 1000 may be performed by any talent scoring system and, for example, may be performed by talent scoring system 112, which was previously described.

Process 1000 begins at acts 1002 and 1004, where the talent scoring system obtains a candidate's credentials and credential value preferences for a job, respectively. This may be done in any suitable way, examples of which have been described.

Next, process 1000 proceeds to act 1006, where a talent score for the candidate is calculated based on the candidate's existing preferences (obtained at act 1002) and the credential value preferences (obtained at act 1006). This may be done in any suitable way and, for example, may be done by using the techniques described with reference to FIGS. 5A, 5B, and 6.

Next, process 1000 proceeds to act 1008, where the talent scoring system may identify one or multiple credentials that the candidate does not possess. This may be done in any suitable way. In some embodiments, the talent scoring system may identify one or more credentials that the candidate does not possess by using the credentials obtained at act 1002. For example, the talent scoring system may have access to one or more lists of credentials that candidates may have, in general, and may compare these lists(s) with the candidate's credentials obtained at act 1002 to determine which credential(s) the candidate does not possess. It should be appreciated that the talent scoring system may identify any suitable number of credentials that the candidate does not possess. For example, in some embodiments, the talent scoring system may identify some but not all credentials that the candidate does not possess, as a talent scoring system is not limited to identifying all credentials that a candidate does not possess.

Any suitable credentials of any suitable type may be identified at act 1008. For example, the talent scoring system may identify one or more courses that the candidate has not taken. As another example, the talent scoring system may identify one or more degrees (e.g., graduate degrees) that the candidate has not obtained. As yet another example, the talent scoring system may identify one or more competitions that the candidate has not entered and/or placed in. As yet another example, the talent scoring system may identify one or more publications the candidate has not published.

Next, process 1000 proceeds to act 1010, where the talent scoring system evaluates the effect of augmenting the candidate's credentials with one or more of the identified credentials on the candidate's talent score. This may be done in any suitable way. For example, in some embodiments, the talent scoring system may (1) augment the candidate's credentials with one new credential identified at act 1008 and (2) calculate the candidate's talent score based on the augmented credentials. The talent scoring system may repeat these two steps for each of the credentials identified at act 1008. Accordingly, the talent scoring system may calculate a talent score for each one of the credentials identified at act 1008 as though the candidate had that credential. As another example, in some embodiments, the talent scoring system may (1) augment the candidate's credentials with multiple credentials that the candidate does not have and (2) calculate the candidate's talent score based on the augmented credentials. The talent scoring system may repeat these two steps for each of multiple groups of multiple credentials.

As described above, a talent scoring system may calculate a candidate's talent score based on the candidate's credentials augmented by one or more credentials the candidate does not have. This may be done in any suitable way. For example, in some embodiments, the talent scoring system may obtain at least one value for at least one new credential and calculate the talent score based at least in part on the at least one value of the at least one new credential, at least one value of at least one of the candidate's existing credentials (i.e., credentials obtained at act 1002) and the credential value preferences. The credential value preferences may specify at least one preferred value for one or more of the candidate's existing credentials. Additionally, credential value preferences may specify one or more preferred values for the at least one new credential.

Next, process 1000 proceeds to act 1012, where the talent scoring system may identify which credential(s), among those identified at act 1008, to recommend to the candidate to obtain. This may be done in any suitable way and, for example, may be done based on the talent scores calculated by using the identified credentials, at act 1010. For example, the talent scoring system may identify which of the identified credentials, when augmenting the candidate's existing credentials, result in the largest increase (or largest increases) of the candidate's talent score (which was calculated at act 1006 based only on the candidate's existing credentials). The system may identify the credential leading to the largest, the two credentials leading to the two largest, the three credentials leading to the three largest increases in the candidate's talent score. As another example, the talent scoring system may identifying which of the identified credentials, when augmenting the candidate's existing credentials, result in an increase of the candidate's talent score (which was calculated at act 1006) that is greater than a threshold. As another example, the system may rank the identified credentials based on their respective talent scores and identify a number of credentials at the top of the ranking to recommend to the candidate to obtain.

The talent scoring system may recommend these credentials to the candidate in any suitable way, as aspects of the disclosure provided herein are not limited in this respect. After act 1012, process 1000 completes.

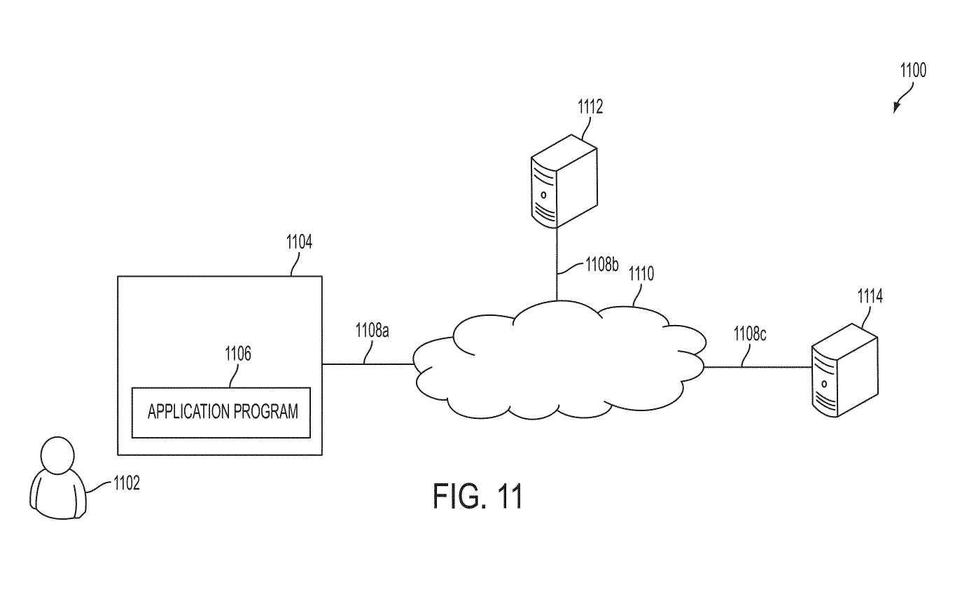

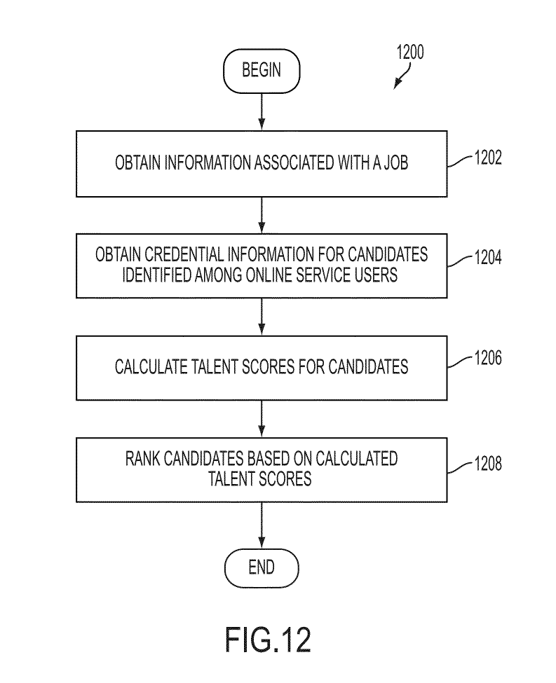

As discussed above, some embodiments provide for an application program that receives profile information of individuals identified via a user search on an online service (e.g., a professional website) and generates a talent score for these individuals, with or without an accompanying measure of uncertainty (e.g., a confidence interval). Such an application may help employers identify the candidates, from among users in an online professional service (e.g., LinkedIn®, Monster®, etc.), that are best suited for one or more jobs. These embodiments are described in more detail below with reference to FIGS. 11 and 12.

FIG. 11 shows an illustrative environment 1100 in which some embodiments, related to identifying candidates from among users in an online service of professionals, may operate. In the illustrative environment 1100, a user 1102 (e.g., an employer) may use computing device 1104 to interact with, via network 1110, an online service 1114 (e.g., provide by one or more servers connected to network 1110) to search for one or more candidates for one or more jobs. Additionally, user 1102 may use computing device 1104 to interact with, via network 1110, talent scoring system 1112 to obtain talent scores for one or more candidates identified among the users in online service 1114.

In some embodiments, user 1102 may use an application program 1106 executing on computing device 1104 (e.g., a browser or other network interface application) to access the online service 1114 and search for candidates for one or more jobs among the users of the online service 1114. User 1102 may input a search query specifying information associated with a job to the application program 1106, the application program 1106 may transmit a representation of the search query to online service 1114, the online service 1114 may perform a search for users of the service based, at least in part, on the search query and provide the search results (e.g., information specifying identified users of, or associated with, the online service, such as a list of identified online service users) to the application program 1106. In turn, application program 1106 may present the search results to user 1102.

In some embodiments, the user 1102 may obtain a talent score for one or more of the online service users identified in response to the user's query. For example, the user 1102 may obtain a talent score for one or more of the identified online service users from talent scoring system 1112. Application program 1106 or a portion thereof (or another application program executing on device 1104 and configured to communicate with application program 1106, such as a plug-in application configured for program 1106) may be configured to provide to talent scoring system 1112 any suitable information used by talent scoring system 1112 to calculate talent scores for one or more of the identified online service users. For example, application program 1106 may be configured to provide to talent scoring system 1112 information about the identified online service users that was obtained from online service 1114 (e.g., credential information for each of one or more of the identified online service users). Additionally or alternatively to obtaining or receiving information about online service users from computing device 1104 (e.g., via application program 1106), talent scoring system 1112 may be configured to obtain any suitable information about online service users directly from online service 1114. As another example, application program 1106 may be configured to provide to talent scoring system 1112 information associated with the job (e.g., the search query provided to online service 1114, credential value preferences for the job, etc.). In turn, talent scoring system 1112 may be configured to calculate talent scores for the identified online service users and provide the results to application 1106. Application 1106 may then rank the identified online service users based on their talent scores. In this way, when online service 1114 identifies many online service users such that it is difficult or undesirable for user 1102 to consider each identified online service users, talent scores computed by talent scoring system 1112 may allow the user 1102 to focus his/her attention on those online service users that are most suitable for the job for which user 1102 is looking to find candidates.

Computing device 1104 may be any suitable computing device which user 1102 may use to interact with talent scoring system 1112 and online service 1114. For example, computing device 1104 may be a fixed or a portable computing device, examples of each of these types of devices have been provided above with reference to FIG. 1. Network 1110 may be any suitable network such as a local area network, a wide area network, a corporate intranet, the Internet, and/or any other suitable network. As shown, computing device 1104 is coupled to network 1110 via connection 1108a, talent scoring system is coupled to network 1110 via connection 1108b, and online service 1114 may be coupled to network 1110 via connection 1108c. These connections may be wired, wireless, and/or any other suitable type of connection, as aspects of techniques described herein are not limited for use with any particular network configuration, connection type or implementation.

Application program 1106 may be an Internet browser (e.g., a web browser) or a stand-alone application program configured to communicate with online service 1114. Application program 1106 may also be configured to communicate with talent scoring system 1112. As described above, in embodiments where application program 1106 is a browser, application program 1106 may be configured to communicate with talent scoring system 1112 via a plug-in application program. As such, talent scoring system 1112 may provide program functionality rendered and/or operating on computing device 1104 that allows communication with talent scoring system 1113. Such program functionality may be provided as part of, integrated or otherwise accompanying, or separate from application program 1106, as the techniques for scoring users of an online service are not limited for use with any particular configuration or implementation.

Talent scoring system 1112 may be any suitable type of talent scoring system such as, for example, talent scoring system 112 described with reference to FIG. 1. Talent scoring system 1112 may be configured to calculate talent scores for candidates in accordance with the techniques for calculating talent scores described herein (e.g., the techniques described with reference to FIGS. 5A, 5B, and 6). For example, talent scoring system 1112 may be configured to calculate a talent score for a candidate, based on the candidate's credentials and an employer's credential value preferences, by calculating a value for each of one or more of the candidate's credentials (e.g., credentials available via the online service) and determining how well the values of the candidate's credentials align with the employer's credential value preferences.

Online service 1114 may be any online website and/or service that has access to information its users, which may include one or more credentials. The online service may provide an interface for searching among users of the online service. For example, the online service may be an online network of users (e.g., LinkedIn®), an online service for job seekers (e.g., Monster®), and/or any other suitable type of online service. The online service may be a professional network for use by professionals (e.g., LinkedIn®), a social network online service (e.g., Facebook®), and/or any other suitable type of online service that has access to information about the credentials of at least some of its users. The online service may make information about its users available via a web-based interface, an application programming interface (API), and/or in any other suitable way.

It should be appreciated that environment 1100 is illustrative and that variations of environment 1100 are possible. For example, in some embodiments, talent scoring system 1112 and computing device 1104 may be one device (e.g., talent scoring software may execute on computing device 1104). As another example, in some embodiments, user 1102 may use device 1104 to interact with talent scoring system 1112, which in turn may be configured to communicate directly with online service 1114 such that user 1102 need not access online service 1114 directly and may search for one or more users of online service 1114 via an interface (e.g., a web interface) provided by talent scoring system 1112. Computing device 1104 may be any suitable computing device including, but not limited to, user terminals, personal computers, mobile devices such as laptops, pads, smart phones, etc., or any other computing device capable of communicating with network 1110. Network 1110 may be any combination of one or more public and/or private networks capable of allowing connected components to communicate, either directly or indirectly.

FIG. 12 is a flow chart of an illustrative process 1200 performed by a talent scoring system of calculating talent scores for candidates identified from among users of or associated with an online service, in accordance with some embodiments. Illustrative process 1200 may be performed by any talent scoring system and, for example, may be performed by exemplary talent scoring systems 1112 or 112 as described herein.

Process 1200 begins at act 1202, where the talent scoring system obtains information associated with a job and/or a skill or particular set of skills. Information associated with a job may include any information describing the job, describing the types of candidates an employer may be seeking to hire for the job, credential value preferences for a job, and/or any other suitable information. Credential value preferences for the job (and/or any other type of information associated with the job) may be obtained in any suitable way, examples of which have been described.

Next, process 1200 proceeds to act 1204 where credential information for one or more users identified among users of an online service may be obtained by the talent scoring system. The online service may be any suitable online website and/or service via which credentials of one or more users may be accessed (e.g., LinkedIn®, Monster®, etc.). Credential information of a user of an online service may be obtained by the talent scoring system directly from the online service (e.g., talent scoring system 1112 may obtain credential information of an online service user directly from online service 1114) or indirectly (e.g., user 1102, such as an employer searching for candidates for a job, may obtain credential information of the online service user from online service 1114 and provide the credential information to talent scoring system 1112).

The users whose credential information is obtained by the talent scoring system at act 1204 of process 1200 may be identified from among the users of the online service based on information provided by a user seeking to identify candidates suitable for a job from among users in the online service (e.g., user 1102, such as an employer). For example, as described above with reference to FIG. 11, a user may submit a search query to the online service to find candidates suitable for a job and the online service may identify one or more candidates, among the users of the online service, based on the search query. The search query may be any desired query that, for example, pertains to a job, one or more skills, or any may include other keywords the user submitting the search query desires or finds useful. The user may submit the search query directly to the online service and/or via the talent scoring system executing process 1200. Though it should be appreciated that users whose credential information is obtained by the talent scoring system at act 1204 of process 1200 may be identified from among the users of the online service in any other suitable way.

After the credentials of one or more online service users are obtained at act 1204, process 1200 proceeds to act 1206 where a talent score is calculated for one or more of the online service users whose credentials have been obtained. The talent score for a candidate may be calculated based, at least in part, on the candidate's credentials (obtained at act 1204) and information associated with the job (obtained at act 1202). This may be done in any suitable way including in any of the ways described herein with reference to FIGS. 5A, 5B, and 6. For example, a talent score for a candidate may be obtained by calculating a value for each of one or more of the candidate's credentials and determining how well the values of the candidate's credentials align with the employer's credential value preferences. In some embodiments, a measure of uncertainty (e.g., a confidence interval) may be obtained for each of one or more of the talent scores calculated at act 1206 (e.g., as described with reference to FIG. 5B).

Next process 1200 proceeds to act 1208, where the online service users are ranked based on their respective talent scores. In some embodiments, when measures of uncertainty for the talent scores are available, online service users may be ranked based on their talent scores and the corresponding measures of uncertainty. This may be done in any suitable way. As an example, the online service users may be ranked based on their talent scores and when two users have the same talent score, the user whose score has a higher confidence may be ranked ahead of the other user. As another example, a user with a talent score that is smaller than the talent score of another user, but whose talent score is associated with a higher confidence than that of the other user, may be ranked ahead of the other user.

As may be appreciated from the foregoing, the ranking of online service users generated at act 1208 of process 1200 may be different from the ranking of these same users generated by the online service in response to information provided by a user seeking to identify candidates suitable for a job from among users in the online service. For example, in response to a user's search query, the online service may present the user with a list of online service users identified based on the query, as described above with reference to FIG. 11. This list of users may be ordered in accordance with how well each of the online service users matches the search query or the list of user may be presented alphabetically, in the order in which they were matched, based on their relationship to the user submitting the query, or in any other order. However, when the users in the list are ranked based on their talent scores, the resulting ranking may be (and most likely is) different from the ordering of the users in this list generated by the online service. After the ranking is generated, process 1200 completes. As a result, the user may obtain a ranked list of user based upon talent scores for the users.

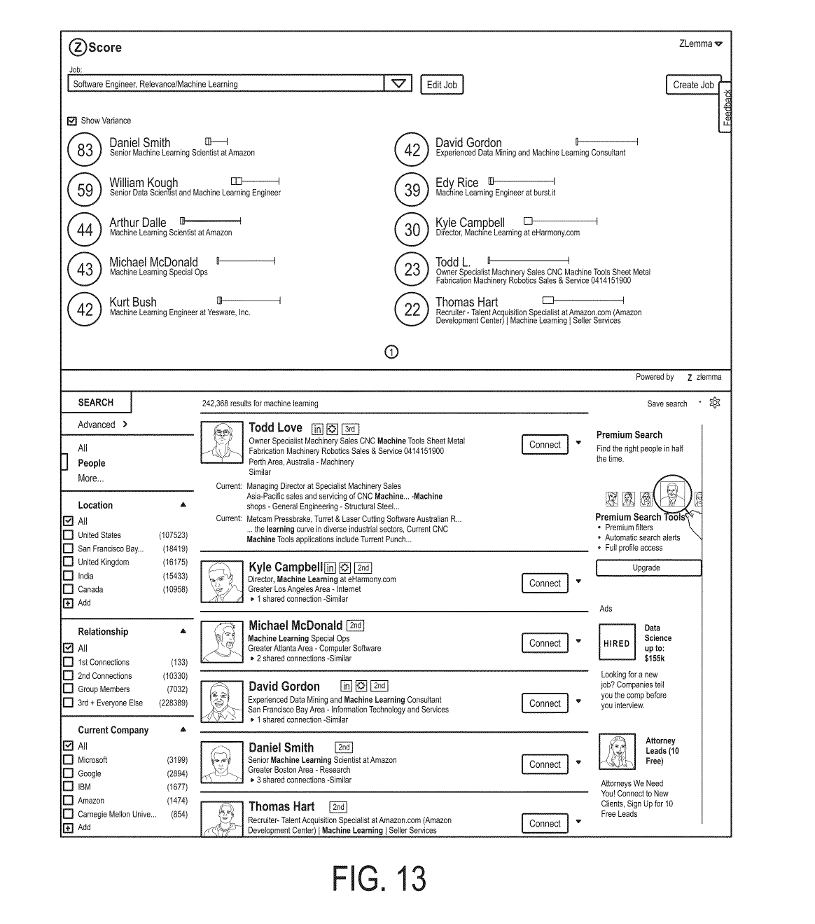

The talent scores and/or rankings obtained for online service users generated by using process 1200 may be presented to a user (e.g., an employer searching for suitable job candidates among online service users, user 1102 described with reference to FIG. 11, etc.) or used in any other suitable way. One illustration for how talent scores for online service users may be displayed is shown in FIG. 13. The interface shown in FIG. 13 was obtained by searching an online service (LinkedIn® in this example) using the search query “machine learning,” and subsequently scoring at least some of the identified users for the job of “Software Engineer, Relevance/Machine Learning,” for which the employer specified credential value preferences (e.g., by clicking the ‘create job’ button and specifying credential value preferences and/or any other information associated with the job). The top talent scores are shown in the top portion of the illustrative interface, with some of the talent scores being shown together with corresponding measures of uncertainty. It should be appreciated that some of the top-scoring candidates (based on their talent scores) are not shown by LinkedIn® on the first page of (over 200,000 online service users). Without a talent scoring system to identify such candidates, an employer would have had to review a very large number of online service users and would have likely given up before finding the most suitable candidates. Accordingly, aspects of techniques described herein may facilitate identifying and evaluating candidates via existing online services.

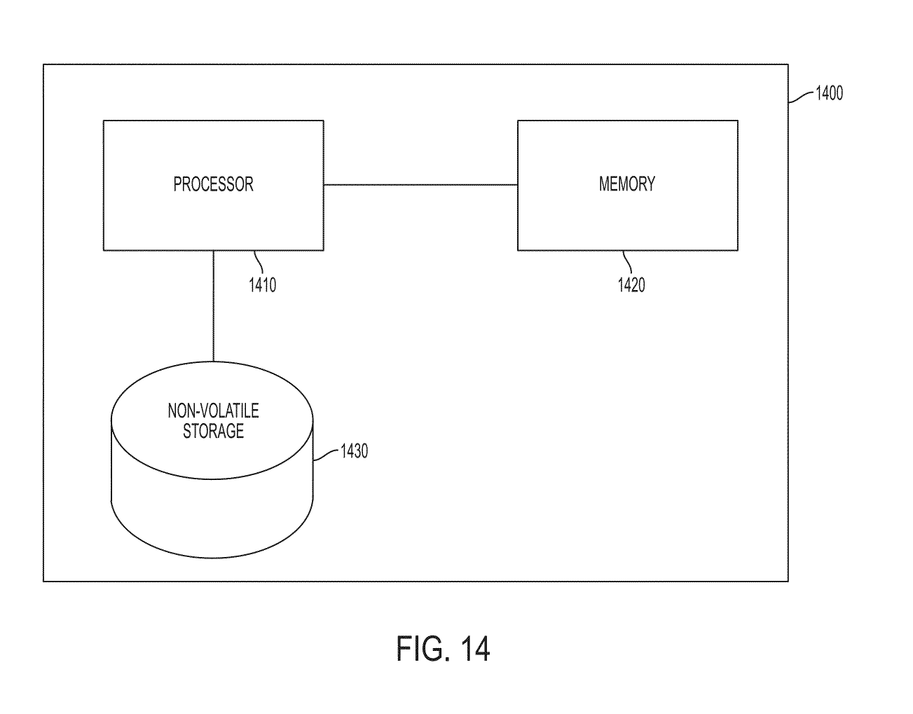

An illustrative implementation of a computer system 1400 that may be used to implement one or more of the scoring or evaluation techniques, or to perform one or more other services, described herein is shown in FIG. 14. Computer system 1400 may include one or more processors 1410 and one or more non-transitory computer-readable storage media (e.g., memory 1420 and one or more non-volatile storage media 1430). The processor 1410 may control writing data to and reading data from the memory 1420 and the non-volatile storage device 1430 in any suitable manner, as the aspects of the invention described herein are not limited in this respect.

To perform functionality and/or techniques described herein, the processor 1410 may execute one or more instructions stored in one or more computer-readable storage media (e.g., the memory 1420, storage media, etc.), which may serve as non-transitory computer-readable storage media storing instructions for execution by the processor 1410. Computer system 1400 may also include any other processor, controller or control unit needed to route data, perform computations, perform I/O functionality, etc. For example, computer system 1400 may include any number and type of input functionality to receive data and/or may include any number and type of output functionality to provide data, and may include control apparatus to operate any present I/O functionality.

In connection with the scoring techniques and other evaluation and recommendation services described herein, one or more programs configured to receive information, evaluate data, determine one or more talent scores and/or provide information to employers and/or candidates may be stored on one or more computer-readable storage media of computer system 1400. Processor 1410 may execute any one or combination of such programs that are available to the processor by being stored locally on computer system 1400 or accessible over a network. Any other software, programs or instructions described herein may also be stored and executed by computer system 1400. Computer 1400 may be a standalone computer, server, part of a distributed computing system, mobile device, etc., and may be connected to a network and capable of accessing resources over the network and/or communicate with one or more other computers connected to the network.

Implementation of some of the techniques described herein (e.g., computing talent scores) on a computer system such as computer 1400 is an integral component of practicing these techniques, as aspect of these techniques cannot be realized absent computer implementation. At least part of the inventor's insight is derived from the recognition that widespread, automated, distributed talent scoring can only be implemented using a computer system. In addition, techniques described herein that are performed by one or more computers are capable of quantifying matches in an objective, distributed and saleable manner not possible using manually driven approaches.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples (see e.g., FIGS. 2-4, 5A-B, 6, 10, and 12) have been provided. The acts performed as part of each process may be ordered in any suitable way. Accordingly, embodiments may be constructed in which acts are performed in an order different than illustrated, which may include performing some acts concurrently, even though shown as sequential acts in illustrative embodiments.

All definitions, as defined and used herein, should be understood to control over dictionary definitions, and/or ordinary meanings of the defined terms.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A method comprising:
using at least one hardware computer processor to perform:
calculating a first value for a first credential of a candidate for a job and a measure of uncertainty for the first value, the first credential indicative of the candidate's knowledge and/or skill in a first area, the first value indicative of an amount of knowledge and/or skill the candidate has in the first area;
obtaining an employer's credential value preferences for the job; and
calculating a talent score for the candidate and a corresponding measure of uncertainty based, at least in part, on the first value, the credential value preferences, and the measure of uncertainty for the first value.

2. The method of claim 1, wherein calculating the measure of uncertainty for the first value is performed based on a magnitude of the first value.

3. The method of claim 1, wherein calculating the measure of uncertainty for the first value is performed based on a type of the first credential.

4. The method of claim 1, wherein the measure of uncertainty for the first value comprises a first interval represented by a first minimum value smaller than the first value and a first maximum value greater than the first value.

5. The method of claim 4, wherein a difference between the first value and the first minimum value is not the same as a second difference between the first maximum value and the first value.

6. The method of claim 1, further comprising:
calculating a second value for a second credential of the candidate for the job and a measure of uncertainty for the second value, the second credential indicative of the candidate's knowledge and/or skill in a second area, the second value indicative of an amount of knowledge and/or skill the candidate has in the second area,
wherein calculating the measure of uncertainty for the talent score comprises combining the measure of uncertainty for the first value and the measure of uncertainty for the second value.

7. The method of claim 6,
wherein the measure of uncertainty for the first value comprises a first interval represented by a first minimum value and a first maximum value,
wherein the measure of uncertainty for the second value comprises a second interval represented by a second minimum value and a second maximum value, and
wherein combining the measure of uncertainty for the first value and the measure of uncertainty for the second value comprises calculating a third interval represented by a third minimum value calculated as a weighted sum of the first and second minimum values and a third maximum value calculated as a weighted sum of the first and second maximum values.

8. The method of claim 1, wherein the employer's credential value preferences for the job specify an employer's preference for an amount of uncertainty associated with talent scores of candidates for the job.

9. At least one non-transitory computer-readable storage medium storing processor-executable instructions that, when executed by at least one hardware computer processor, cause the at least one hardware computer processor to perform a method comprising:
calculating a first value for a first credential of a candidate for a job and a measure of uncertainty for the first value, the first credential indicative of the candidate's knowledge and/or skill in a first area, the first value indicative of an amount of knowledge and/or skill the candidate has in the first area;
obtaining an employer's credential value preferences for the job; and
calculating a talent score for the candidate and a corresponding measure of uncertainty based, at least in part, on the first value, the credential value preferences, and the measure of uncertainty for the first value.

10. The at least one non-transitory computer-readable storage medium of claim 9, wherein calculating the measure of uncertainty for the first value is performed based on a magnitude of the first value and/or the type of the first credential.

11. The at least one non-transitory computer-readable storage medium of claim 9, wherein the measure of uncertainty for the first value comprises a first interval represented by a first minimum value smaller than the first value and a first maximum value greater than the first value.

12. The at least one non-transitory computer-readable storage medium of claim 11, wherein a difference between the first value and the first minimum value is not the same as a second difference between the first maximum value and the first value.

13. The at least one non-transitory computer-readable storage medium of claim 9, further comprising:
calculating a second value for a second credential of the candidate for the job and a measure of uncertainty for the second value, the second credential indicative of the candidate's knowledge and/or skill in a second area, the second value indicative of an amount of knowledge and/or skill the candidate has in the second area,
wherein calculating the measure of uncertainty for the talent score comprises combining the measure of uncertainty for the first value and the measure of uncertainty for the second value.

14. The at least one non-transitory computer-readable storage medium of claim 9,
wherein the measure of uncertainty for the first value comprises a first interval represented by a first minimum value and a first maximum value,
wherein the measure of uncertainty for the second value comprises a second interval represented by a second minimum value and a second maximum value, and
wherein combining the measure of uncertainty for the first value and the measure of uncertainty for the second value comprises calculating a third interval represented by a third minimum value calculated as a weighted sum of the first and second minimum values and a third maximum value calculated as a weighted sum of the first and second maximum values.

15. A system comprising:
at least one hardware computer processor configured to perform:
calculating a first value for a first credential of a candidate for a job and a measure of uncertainty for the first value, the first credential indicative of the candidate's knowledge and/or skill in a first area, the first value indicative of an amount of knowledge and/or skill the candidate has in the first area;
obtaining an employer's credential value preferences for the job; and
calculating a talent score for the candidate and a corresponding measure of uncertainty based, at least in part, on the first value, the credential value preferences, and the measure of uncertainty for the first value.

16. The system of claim 15, wherein the at least one hardware computer processor is configured to perform calculating the measure of uncertainty for the first value based on a magnitude of the first value and/or the type of the first credential.

17. The system of claim 15, wherein the measure of uncertainty for the first value comprises a first interval represented by a first minimum value smaller than the first value and a first maximum value greater than the first value.

18. The system of claim 15, wherein a difference between the first value and the first minimum value is not the same as a second difference between the first maximum value and the first value.

19. The system of claim 15, wherein the at least one hardware processor is further configured to perform:
calculating a second value for a second credential of the candidate for the job and a measure of uncertainty for the second value, the second credential indicative of the candidate's knowledge and/or skill in a second area, the second value indicative of an amount of knowledge and/or skill the candidate has in the second area,
wherein calculating the measure of uncertainty for the talent score comprises combining the measure of uncertainty for the first value and the measure of uncertainty for the second value.

20. The system of claim 15,
wherein the measure of uncertainty for the first value comprises a first interval represented by a first minimum value and a first maximum value,
wherein the measure of uncertainty for the second value comprises a second interval represented by a second minimum value and a second maximum value, and
wherein combining the measure of uncertainty for the first value and the measure of uncertainty for the second value comprises calculating a third interval represented by a third minimum value calculated as a weighted sum of the first and second minimum values and a third maximum value calculated as a weighted sum of the first and second maximum values.
